(19) United States
(12) Patent Application Publication
(10) Pub. No.: US 2026/0004354 A1
(43) Pub. Date: Jan. 1, 2026

(54) SYSTEMS AND METHODS FOR HYPER-PERSONALIZING DIGITAL ACTIONS AND INTERFACES

(71) Applicant: Wells Fargo Bank, N.A., San Francisco, CA (US)

(72) Inventors: Markell Byrd, Ladera Ranch, CA (US); Chanty Clay, Edwardsville, IL (US); Karen McLean, Boston, MA (US); David Furst, Saint Louis, MO (US); Dalton Butler, Jacksonville, FL (US); Justin Morris Krieger, Saint Louis, MO (US)

(21) Appl. No.: 19/252,942

(22) Filed: Jun. 27, 2025

Related U.S. Application Data
(60) Provisional application No. 63/665,115, filed on Jun. 27, 2024.

(51) Int. Cl. G06Q 40/06

(52) U.S. Cl. CPC G06Q 40/06

(57) ABSTRACT

Systems, apparatuses, methods, and computer program products are disclosed for hyper-personalizing digital actions and interfaces. An example method includes receiving user narrative data associated with a user. The method also includes determining a pillars of understanding (POU) alignment dataset for the user based at least on the user narrative data. The method also includes determining an archetype dataset for the user based at least on a portion of the POU alignment dataset. The method also includes generating a hyper-personalized graphical user interface (GUI) based on the POU alignment dataset and the archetype dataset. The method also includes causing presentation of the hyper-personalized GUI at a user device associated with the user. The method also includes performing, based on at least one of the POU alignment dataset and the archetype dataset, an action set in connection with one or more user interactions with the hyper-personalized GUI.

### CROSS-REFERENCE TO RELATED APPLICATIONS

This application claims the benefit of U.S. Provisional Patent Application 63/665,115, filed Jun. 27, 2024, the entire contents of which are incorporated herein by reference.

### BACKGROUND

A lack of personalized representation can make digital interactions seem cold and impersonal, which may diminish user engagement.

### BRIEF SUMMARY

Personalizing digital experiences (such as digital interactions with various graphical user interfaces of a mobile application, website, and/or the like) to reflect an individual's values, background, and/or preferences helps foster inclusivity and a sense of belonging. Digital experiences that lack personalization often exhibit low user engagement and short session durations, which can hinder the ability of an entity delivering the digital experience to effectively guide its user base to relevant solutions and deepen relationships with its user base.

In some examples, a digital experience may be delivered by a system that provides financial advice or recommendations to a person in service of financial and/or life goals, e.g., through a financial institution. However, these types of digital experiences often involve impersonal and overwhelming onboarding (leaving new users unsure of where to start), generic and poorly categorized content delivery, linear and inflexible financial coaching with a lack of emotional support, and otherwise basic outputs that do not empower users over the long-term. Many existing systems that provide financial advice often prioritize the sale of financial products over genuinely assisting people in achieving financial and/or life goals. Consequently, recommendations output by these systems may be skewed toward offerings that maximize profitability for a provider of the system rather than the most optimal outcome for the person.

Additionally, existing systems also fail to incorporate relevant user data when engaging with and providing solutions for users. For example, while basic financial information and may be considered, these systems lack sophistication to account for broader contextual factors such as user backgrounds, preferences, values, aspirations, systemic challenges and/or barriers, and the like. Consequently, output provided by these systems may not adequately reflect real-time needs and priorities of its users. These systems also fail to analyze current user sentiment in real-time and dynamically modify digital experiences based on current sentiment.

Further, these conventional systems that provide financial advice or recommendations are often only tailored to customers and ignore other individuals playing a role in the financial health of customers, such as financial advisors. Said differently, while existing systems may intake a wealth of user data, process the user data to provide outputs to users, and obtain feedback on the outputs, they lack the capability for other users such as financial advisors, bankers, and the like to interface with the systems in an appropriate manner to gain insights into the user data and/or feedback to better serve their own client base.

Technical challenges are introduced when personalizing digital experiences for users at scale. For instance, there is not a “one size fits all” approach, as people come from all walks of life with different backgrounds and customs that carry over into their financial lives and influence financial behaviors. Delivering hyper-personalized digital experiences effectively at scale therefore becomes extremely resource-intensive due to requiring dynamic and context-aware processing across a large and heterogeneous user base. Thus, efficient architectures and frameworks as disclosed herein are required to produce effective hyper-personalized digital user experiences while minimize scaling issues and other technical issues.

The present disclosure sets forth systems, methods, and apparatuses for hyper-personalizing digital actions and interfaces. As further discussed herein, there are many technical advantages of these and other embodiments such as, for example, enhanced user engagement, enhanced user interface design, improved scalability (e.g., reduced need for extensive redesigns), improved data collection and analysis, increased compliance and security, more robust market reach, improved user satisfaction, and enhanced reputation.

In various example embodiments, example embodiments set forth a transformative approach to empathic hyper-personalization by integrating empathic artificial intelligence (AI) to deliver hyper-personalized user experiences. As mentioned above, current tools underperform due to efficiency gaps and a lack of personalized engagement. Example embodiments address these shortcomings to enhance user relationships, drive digital engagement, and improve product utilization, while also bringing forth new technical improvements to the technical field of dynamic graphical user interface generation.

In various example embodiments, a hyper-personalization system leverages a specifically configured modeling engine that includes, among other circuitries, an empathic AI engine to create hyper-personalized digital experiences that dynamically adapt to communication styles, needs, and behavioral propensities of its users. In various embodiments, this may comprise capturing and analyzing user narratives to understand individual values, emotional contexts, and communication preferences. Additionally, in various embodiments, a POU framework is employed to map narratives to core client dimensions (e.g., a core values dataset, an aspirations dataset, and a pain points dataset as further described herein). In various embodiments, an archetype mix may then be determined to predict behavioral tendencies and tailor digital interactions. Further, in various embodiments, empathic AI agents are utilized to deliver dynamic, hyper-personalized, and interactive experiences integrated with targeted solutions, offerings, and recommendations.

In various embodiments, the hyper-personalization system may facilitate user communications with users that demonstrate an understanding of feelings, concerns, and motivations of users, fostering trust and rapport, while providing a hyper-personalized digital experience in an interactive format that encourages active participation and provides personalized feedback and support. In various embodiments, the hyper-personalized digital user experience may evolve based on user interactions and feedback, continuously learn and update underlying models and processes, and dynamically adapt to ever-shifting needs and emotional states of users. In various embodiments, the hyper-personalization system may anticipate user needs and offer timely and relevant guidance with a focus on emotional support and encouragement. Additionally, in various embodiments, the hyper-personalization system may seamlessly integrate with various disparate data sources to determine and provide solutions that are presented in a contextual and empathic manner, empowering users to take action with confidence. In various embodiments, the hyper-personalization system exhibits culturally sensitivity by providing inclusive and equitable digital experiences that recognize and respect the diverse cultural backgrounds and financial behaviors of its user base.

As described further herein, in various embodiments, the hyper-personalization system may process user narratives to extract key information, sentiment, tone, emotional cues, and linguistic features. In various embodiments, machine learning techniques including, for example, classification and clustering may be leveraged to analyze user data and narrative features to determine alignment with a POU framework. In various embodiments, a modeling engine may be leveraged to determine an archetype dataset based on a POU alignment dataset. Additionally, the system may classify or cluster users based on their archetype dataset and develop emotional and/or behavioral profiles for hyper-personalized digital experience generation and solution surfacing. To support this, generative AI may be utilized to generate text and interactive content to be delivered with empathy. This may include, for example, generating personalized content summaries, offering surfacing, conversational prompts, and interactive experience visualizations that are not only informative but also empathetic, supportive, and tailored to individual emotional needs. In various embodiments, a hyper-personalized digital experience may surface relevant content, provide next steps in a user's financial journey or similar venture, and enable appropriate product and/or service off-ramps based on user profile(s), archetypes, POU alignment, historical interactions, current financial needs, and inferred emotional state of a given user.

To integrate and process both textual and audio and/or visual data effectively, hyper-personalization system may employ multimodal AI with emotion recognition to recognize and response to nonverbal cues and enhance the interactive and empathetic nature of a hyper-personalized digital experience. This may include, for example, dynamically generating and causing display of interface elements such as visual progress indicators, dynamic charts, empathetic avatars, and/or the like. In various embodiments, empathic AI agents may be specifically configured to interact with users in a way that demonstrates empathy, understanding, and emotional intelligence. In some embodiments, empathic AI agents may take on distinct roles that correlate with POU alignment datasets and archetype datasets, as further described herein.

In various embodiments, hyper-personalization system may comprise a robust data infrastructure with emotional data capabilities to analyze and respond to emotional data, setting forth a secure and scalable system for collecting, storing, and processing user narrative data and emotional data, POU alignment data, archetype data, interactions, financial literacy content, and product and service data. In various embodiments, hyper-personalization system may comprise a high-quality, well-defined, and validated POU framework for understanding user core values, aspirations, and pain points that as a foundation for empathic understanding. In various embodiments, to determine an archetype dataset for a user which defines an archetype mix, hyper-personalization system may comprise a well-validated and nuanced model for understanding user behavioral propensities and communication styles, derived from pillars of understanding and integrated with emotional and behavioral user profiles.

In various embodiments, hyper-personalization system may seamlessly integrate with various data sources to deliver hyper-personalized digital experiences. These data sources may include a comprehensive and empathetic content library, i.e., a diverse and well-tagged repository of educational resources designed to be delivered with empathy, cultural sensitivity, and emotional support. These data sources may also include an up-to-date product and service database, i.e., a regularly updated database of an entity's financial offerings with accurate metadata, including metadata indicating how the offerings address specific emotional needs and financial concerns.

In various embodiments, the hyper-personalization system may comprise advanced natural language processing (NLP) mechanisms and generative AI models trained on relevant data and capable of understanding nuances in language, generating appropriate content, creating engaging interactive experiences, and, crucially, recognizing and responding to user emotions with empathy. In various embodiments, hyper-personalization system may also facilitate a rigorous testing and validation framework for empathy by providing clear channels for users to provide feedback on their hyper-personalized experiences, their perceived empathy of the hyper-personalization system, and the usefulness of product and/or service off-ramps within their hyper-personalized digital experience, with a focus on capturing emotional responses and subjective feelings.

In various embodiments, the hyper-personalization system may be integrated into a larger digital ecosystem of an entity (e.g., an enterprise, financial institution, etc.) and its connected platforms and/or applications. As mentioned above, users may engage with the hyper-personalization system through dictation, text input, and/or other digital interactions via one or more remote user devices and in turn receive a hyper-personalized digital experience that includes seamless user access to relevant financial solutions. In various embodiments, POU alignment data and archetype data, along with anonymized and aggregated emotional and behavioral insights, may be utilized across other enterprise systems and services (e.g., customer relationship management (CRM) systems, marketing automation, customer service, etc.) to enhance hyper-personalization and empathy across the customer experience.

In some embodiments, the hyper-personalization system and its integrations with connected platforms and/or applications may enable individuals such as financial advisors to gain insights into their client base using deep data-driven understanding of a given client's unique financial motivators, moving beyond surface-level demographics to uncover underlying core values, aspirations and pain points which drive financial decisions. As discussed further herein, the hyper-personalization system may provide financial advisors with unique advisor GUIs that deliver pertinent information regarding users, as well as strategies for personalized advisor and client engagement and prospecting opportunities.

In some embodiments, a method is provided that includes receiving, by communications hardware, user narrative data associated with a user. The method also includes determining, by a modeling engine, a pillars of understanding (POU) alignment dataset for the user based at least on the user narrative data. The method also includes determining, by the modeling engine, an archetype dataset for the user based at least on a portion of the POU alignment dataset. The method also includes generating, by a personalized output generation engine, a hyper-personalized graphical user interface (GUI) based on the POU alignment dataset and the archetype dataset. The method also includes causing, by the communications hardware, presentation of the hyper-personalized GUI at a user device associated with the user. The method also includes performing, by the personalized output generation engine and based on at least one of the POU alignment dataset and the archetype dataset, an action set in connection with one or more user interactions with the hyper-personalized GUI.

In some embodiments, an apparatus is provided that includes communications hardware configured to receive user narrative data associated with a user. The apparatus also includes a modeling engine configured to determine a POU alignment dataset for the user based at least on the user narrative data. The modeling engine is also configured to determine an archetype dataset for the user based at least on a portion of the POU alignment dataset. The apparatus also includes a personalized output generation engine configured to generate a hyper-personalized GUI based on the POU alignment dataset and the archetype dataset. The communications hardware is also configured to cause presentation of the hyper-personalized GUI at a user device associated with the user. The personalized output generation engine is also configured to perform, based on at least one of the POU alignment dataset and the archetype dataset, an action set in connection with one or more user interactions with the hyper-personalized GUI.

In some embodiments, a computer program product is provided that comprises at least one non-transitory computer-readable storage medium storing software instructions that, when executed, cause an apparatus to receive user narrative data associated with a user. The at least one non-transitory computer-readable storage medium further stores software instructions that, when executed, cause the apparatus to determine a POU alignment dataset for the user based at least on the user narrative data. The at least one non-transitory computer-readable storage medium further stores software instructions that, when executed, cause the apparatus to determine an archetype dataset for the user based at least on a portion of the POU alignment dataset. The at least one non-transitory computer-readable storage medium further stores software instructions that, when executed, cause the apparatus to generate a hyper-personalized graphical user interface GUI based on the POU alignment dataset and the archetype dataset. The at least one non-transitory computer-readable storage medium further stores software instructions that, when executed, cause the apparatus to cause presentation of the hyper-personalized GUI at a user device associated with the user. The at least one non-transitory computer-readable storage medium further stores software instructions that, when executed, cause the apparatus to perform, based on at least one of the POU alignment dataset and the archetype dataset, an action set in connection with one or more user interactions with the hyper-personalized GUI.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1A illustrates an example operating environment for a hyper-personalization system in accordance with some example embodiments described herein.

FIG. 1B illustrates various aspects of a hyper-personalization system in conjunction with a user device or entity device in accordance with some example embodiments described herein.

FIG. 2A illustrates a schematic block diagram of example circuitry embodying a system device that may perform various operations in accordance with some example embodiments described herein.

FIG. 2B illustrates a schematic block diagram of an example modeling engine that may perform various operations in accordance with some example embodiments described herein.

FIG. 3 illustrates an example flowchart for hyper-personalizing digital actions and interfaces, in accordance with some example embodiments described herein.

FIG. 4A illustrates example user interfaces for facilitating obtainment of user narrative data, in accordance with some example embodiments described herein.

FIG. 4B illustrates example user interfaces for facilitating obtainment of user narrative data, in accordance with some example embodiments described herein.

FIG. 5 illustrates an example flowchart for continuously collecting user narrative data, in accordance with some example embodiments described herein.

FIG. 6A illustrates an example representation of example pillars of understanding of a hyper-personalized digital experience, in accordance with some example embodiments described herein.

FIG. 6B illustrates an example representation of example core values, aspirations, and pain points of a pillars of understanding alignment dataset, in accordance with some example embodiments described herein.

FIG. 7 illustrates an example flowchart for determining an archetype dataset for a user based at least on a portion of a POU alignment dataset, in accordance with some example embodiments described herein.

FIG. 8 illustrates an example flowchart for prioritizing and surfacing relevant content to a user via a hyper-personalized GUI, in accordance with some example embodiments described herein.

FIG. 9 illustrates an example flowchart for delivering communications via a hyper-personalized GUI, in accordance with some example embodiments described herein.

FIG. 10 illustrates an example user interface for displaying solution list via a hyper-personalized GUI, in accordance with some example embodiments described herein

FIG. 11 illustrates an example flowchart for providing responses to advisor requests via an advisor GUI, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

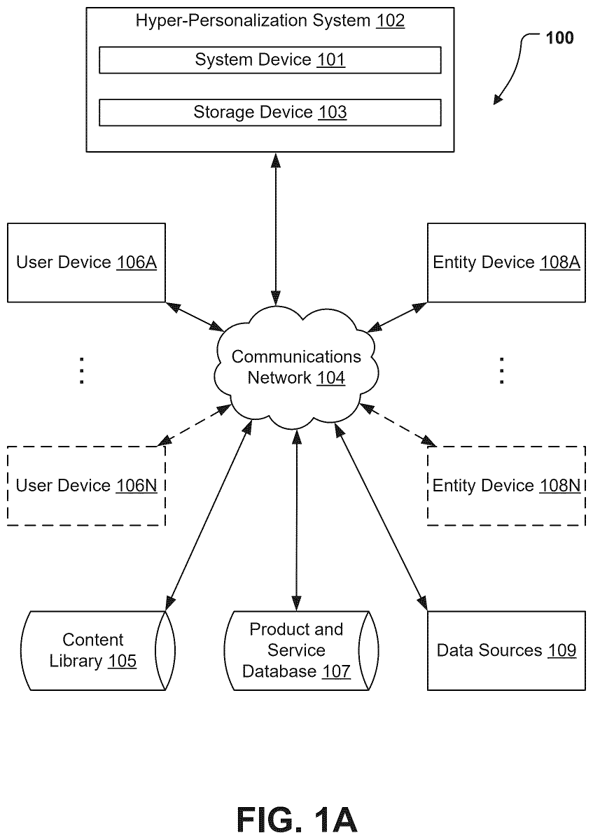

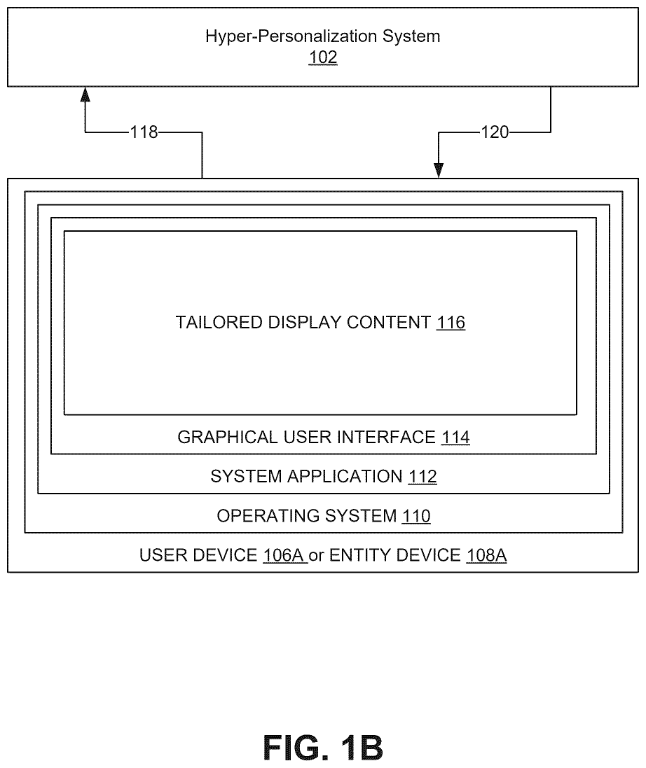

Example embodiments described herein may be implemented using any of a variety of computing devices or servers. To this end, FIG. 1A illustrates an example environment 100 within which various embodiments may operate. As illustrated, a hyper-personalization system 102 may receive and/or transmit information via communications network 104 (e.g., the Internet) with any number of other devices, such as one or more of user devices 106A-106N, entity devices 108A-108N, a content library 105, a product and service database 107, and one or more data sources 109.

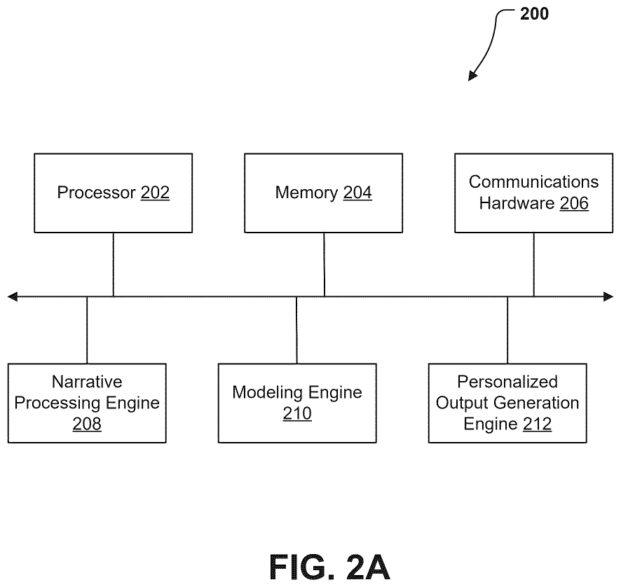

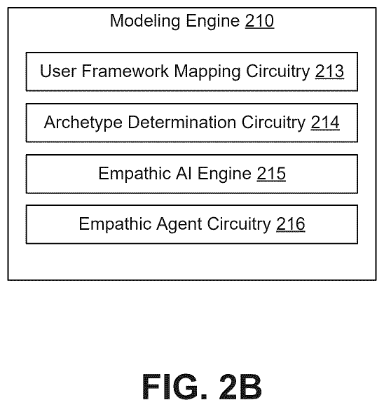

The hyper-personalization system 102 may be implemented as one or more computing devices or servers, which may be composed of a series of components. The hyper-personalization system 102 may include, or be implemented on, one or more computing devices utilized in providing aspects of a mobile application experience, such as one or more servers, cloud services, data stores, and the like. Particular components of the hyper-personalization system 102 are described in greater detail below with reference to apparatus 200 in connection with FIGS. 2A and 2B.

The one or more user devices 106A-106N may be embodied by any computing devices known in the art. For example, user devices 106A-106N may include one or more of a mobile phone, a smart phone, a smart watch, a desktop computer, a laptop computer, a tablet, a virtual or augmented reality headset, and the like. The one or more user devices 106A-106N need not themselves be independent devices but may be peripheral devices communicatively coupled to other computing devices. In various embodiments, the hyper-personalization system 102 (and corresponding system application 112 discussed below in connection with FIG. 1B) may be managed or otherwise facilitated by a financial institution (e.g., a bank). In such embodiments, user devices 106A-106N may correspond to devices of users (i.e., customers or clients of the bank).

The one or more entity devices 108A-108N may be embodied by any computing devices known in the art. For example, entity devices 108A-108N may include one or more of a mobile phone, a smart phone, a smart watch, a desktop computer, a laptop computer, a tablet, a virtual or augmented reality headset, and the like. The one or more entity devices 108A-108N need not themselves be independent devices but may be peripheral devices communicatively coupled to other computing devices. In various embodiments wherein the hyper-personalization system 102 (and corresponding system application 112 discussed below in connection with FIG. 1B) is managed or otherwise facilitated by a financial institution (e.g., a bank), entity devices 108A-108N may correspond to devices of advisors (i.e., financial advisors associated with the bank) and/or other employees or individuals affiliated with the bank.

In various embodiments, content library 105 may comprise a repository comprising a tagged educational resources (e.g., videos, podcasts, books, articles, blogs, interactive games or tools, guides, etc.) designed to be delivered with empathy, cultural sensitivity, and emotional support. In various embodiments, resources included in content library 105 may comprise metadata which categorizes a resource according to its relevant to one or more pillars of understanding, archetypes, and/or the like. In various embodiments, the metadata may also provide emotional context and recommended methods of delivering the resources in an empathetic manner. For example, metadata may comprise data indicating tone, communication style, and the like. As discussed herein, in some embodiments, hyper-personalization system 102 may access and retrieve resources from content library 105 by querying content library 105 using metadata tags.

In various embodiments, product and service database 107 may comprise a regularly updated repository that catalogs offerings of an enterprise (e.g., financial offerings of a bank), such as accounts, credit products, loans, insurance, services, and tools offered. In various embodiments, offerings included in product and service database 107 may comprise metadata that indicates information about a given product or service (e.g., features, prices, eligibility requirements, constraints, etc.). In various embodiments, the metadata may also indicate contextual information that describes how an offering addresses specific financial concerns and emotional needs. As discussed herein, in some embodiments, hyper-personalization system 102 may access and retrieve offerings from product and service database 107 by querying product and service database 107 using metadata tags.

In various embodiments, data sources 109 may be embodied by any computing devices known in the art. In various embodiments, data sources 109 may comprise servers, personal user devices, such as mobile phones, laptops, desktop computers, tablets, and/or the like. In general, data sources 109 may include computing devices which host structured and/or unstructured data in databases or repositories that can be utilized by hyper-personalization system 102. In some embodiments, data sources 109 may comprise both internal data sources and external data sources. The term “internal data sources” refers to devices or systems (e.g., databases, data streams, and/or the like) which are owned, operated, or otherwise managed by an organization that owns, operates, or otherwise manages hyper-personalization system 102. For example, a financial institution, or similar organization may utilize a distributed computing system to conduct various business operations, operate the hyper-personalization system 102 within the distributed computing system, and use internal data sources to obtain relevant data for processes relating to the hyper-personalization system 102 and one or more other systems of the distributed computing system. Internal data sources may include, for example, internal databases, logs, monitoring mechanisms, proprietary systems, and the like. The term “external data sources” refers to devices or systems (e.g., databases, data streams, and/or the like) which are owned, operated, or otherwise managed by entities outside of the organization, such as third-party vendors, entities partnered with the organization, service providers, and the like. In various embodiments, hyper-personalization system 102 may access and retrieve data from data sources 109 using, for example, Application Programming Interfaces (APIs) or similar mechanisms.

In some embodiments, the hyper-personalization system 102 further includes a storage device 103 that comprises a distinct component from other components of the hyper-personalization system 102. Storage device 103 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 103 may host the software executed to operate the hyper-personalization system 102. Storage device 103 may store information relied upon during operation of the hyper-personalization system 102, such as various models that may be used by the hyper-personalization system 102, data and documents to be analyzed using the hyper-personalization system 102, or the like. In addition, storage device 103 may store control signals, device characteristics, and access credentials enabling interaction between the hyper-personalization system 102 and one or more of the user devices 106A-106N, entity devices 108A-108N, content library 105, product and service database 107, data sources 109, and the like.

FIG. 1B illustrates various aspects of a hyper-personalization system 102 in conjunction with an example user device 106A (or entity device 108A) according to one or more embodiments of the current disclosure. Generally, the hyper-personalization system 102 may provide customized experience data 120 to user device 106A to cause tailored display content 116 (corresponding to a hyper-personalized digital experience) to be presented via one or more views of the graphical user interface (GUI) 114 of user device 106A. In various embodiments, the customized experience data 120 may be generated by hyper-personalization system 102 based at least in part on data 118 (e.g., user narrative data, data associated with one or more user interactions, etc.) received from or via the user device 106A. The user device 106A may include a system application 112 accessible via an operating system 110 of the user device 106A. The system application 112 may generate the tailored display content 116 on GUI 114 based on the customized experience data 120. In various embodiments, the system application 112 may be installed by a user. Similarly, in some embodiments, the hyper-personalization system 102 may provide customized experience data 120 to entity device 108A to cause tailored display content 116 (corresponding to an advisor GUI, discussed further herein) to be presented via one or more views of the GUI 114 of entity device 108A. In various embodiments, the customized experience data 120 may be generated by hyper-personalization system 102 based at least in part on data 118 (e.g., advisor requests, etc.) received from or via the entity device 108A. The entity device 108A may include a system application 112 accessible via an operating system 110 of the entity device 108A. The system application 112 may generate the tailored display content 116 on GUI 114 based on the customized experience data 120. It will be appreciated that in various embodiments the system application 112 may not be necessary to view the tailored display content 116. For example, the tailored display content 116 may be viewed via another application, such as a web browser.

The user device 106A may be associated with a user of a system application 112 associated with the hyper-personalization system 102. In some embodiments, the user device 106A may be associated with a certain type of user (e.g., a customer) based on login credentials provided to the system application 112. Similarly, the entity device 108A may be associated with a certain type of user (e.g., a banker, financial advisor, and/or the like) of a system application 112 associated with the hyper-personalization system 102. In some embodiments, the entity device 108A may be associated with an advisor based on login credentials provided to the system application 112.

### Example Implementing Apparatuses

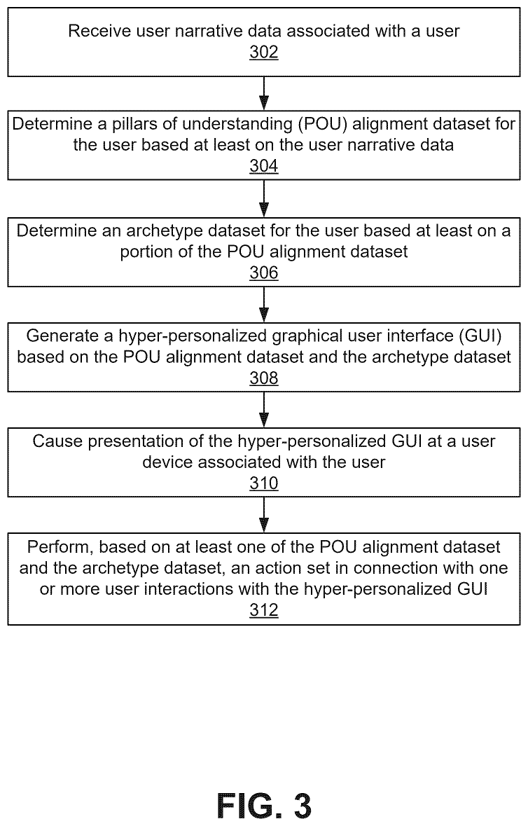

The hyper-personalization system 102 (described previously with reference to FIG. 1A) may be embodied by one or more computing devices or servers, shown as apparatus 200 in FIG. 2A. The apparatus 200 may be configured to execute various operations described above in connection with FIGS. 1A and 1B and below in connection with FIGS. 3-5. As illustrated in FIG. 2A, the apparatus 200 may include processor 202, memory 204, communications hardware 206, narrative processing engine 208, modeling engine 210, and personalized output generation engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a narrative processing engine 208 that processes user narrative data received by hyper-personalization system 102. The narrative processing engine 208 may utilize processor 202, memory 204, or any other hardware component included in the apparatus 200 to perform these operations, as described in connection with FIGS. 3-11 below. The narrative processing engine 208 may further utilize communications hardware 206 to gather data from a variety of sources (e.g., user device(s) 106A-106N, entity devices 108A, 108N, storage device 103, content library 105, product and service database 107, and/or data sources 109, as shown in FIG. 1A), and/or exchange data with a user.

In various embodiments, narrative processing engine 208 may process user narrative data through multiple modalities. For example, narrative processing engine 208 may process user narrative data in the form of audio, video, unstructured text (e.g., free-form text), and semi-structured or structured text (e.g., survey-based responses and/or selections, responses to AI chatbot-based prompts, etc.). In various embodiments, narrative processing engine 208 may process user narrative data to extract features (i.e., a feature set) for use in determining a POU alignment dataset for a user. For example, as further discussed herein, features may be extracted in order to identify a user's core values, aspirations, and pain points, as well as to understand current emotional context regarding the user.

In some embodiments, narrative processing engine 208 may utilize an automatic speech recognition (ASR) pipeline to convert spoken language (e.g., an audio signal from an audio recording or video) into text. Such a pipeline may include use of an ASR algorithm to perform speech recognition and generate a transcript as well as a natural language processing (NLP) model to augment the transcript with various formatting, such as punctuation, capitalization, etc. Example ASR techniques used by narrative processing engine 208 may include Hidden Markov models (HMM) and dynamic time warping (DTW). For example, using a set of transcribed audio samples, an HMM may be trained to predict word sequences by varying the model parameters to maximize the likelihood of the observed audio sequence. DTW is a dynamic programming algorithm that finds the best possible word sequence by calculating the distance between time series (one representing the unknown speech and others representing the known words). In some embodiments, narrative processing engine 208 may utilize deep learning ASR algorithms. In these embodiments, narrative processing engine 208 may utilize a deep learning ASR pipeline that includes data preprocessing using, e.g., a spectrogram generator that converts raw audio to spectrograms, a neural acoustic model that takes the spectrograms as input and outputs a matrix of probabilities over characters over time a decoder that generates possible sentences from the probability matrix, and NLP using, e.g., a punctuation and capitalization model that formats the generated text.

In some embodiments, narrative processing engine 208 may utilize a computer vision model to perform visual signal processing and analyze user facial expressions, eye movement, gestures, and the like to infer non-verbal emotional cues from a video or images. In some embodiments, the computer vision model may comprise a convolutional neural network (CNN).

In some embodiments, narrative processing engine 208 may utilize NLP techniques to process user narrative data in the form of text (e.g., user-provided text, text derived and generated from audio as discussed above, etc.), such as entity recognition, sentiment analysis and the like to derive a feature set. For example, in some embodiments, narrative processing engine 208 may utilize one or more deep learning models (e.g., a CNN, recurrent neural network (RNN), transformers (e.g., BERT), etc.) to detect and classify emotions detected in the text. The one or more deep learning models may be trained on text samples labeled with categories corresponding to emotions. In some embodiments, narrative processing engine 208 may provide the user narrative data (in the form of text) to a trained deep learning model. The trained deep learning model may then process the user narrative data and output probability scores for each emotion category, with the highest probability score corresponding to the emotion most likely conveyed by the text.

Additionally, narrative processing engine 208 may leverage modeling engine 210 to extract features from user narrative data. For example, in some embodiments, narrative processing engine 208 may transmit generated or derived text from user narrative data along with a determined emotion category (as discussed above) to modeling engine 210, which may then utilize a contextual embedding model (e.g., Sentence-BERT or the like) to process the text to determine a POU alignment dataset for the user, as further described below.

In addition, the apparatus 200 further comprises a modeling engine 210 that performs various actions using a plurality of machine learning and artificial intelligence components and models, including, for example, determining a POU alignment dataset for a user, determining an archetype dataset for a user, generating empathic messages and other communications directed to a user, and the like. The modeling engine 210 may utilize processor 202, memory 204, or any other hardware component included in the apparatus 200 to perform these operations, as described in connection with FIGS. 3-11 below. The modeling engine 210 may further utilize communications hardware 206 to gather data from a variety of sources (e.g., user device(s) 106A-106N, entity devices 108A, 108N, storage device 103, content library 105, product and service database 107, and/or data sources 109, as shown in FIG. 1A), and/or exchange data with a user.

Turning briefly to FIG. 2B, a schematic block diagram of an example modeling engine 210 is shown. In some embodiments, modeling engine 210 may comprise user framework mapping circuitry 213, archetype determination circuitry 214, empathic AI engine 215, and empathic agent circuitry 216.

In some embodiments, the modeling engine 210 comprises user framework mapping circuitry 213 that determines a pillars of understanding (POU) alignment dataset for a user based at least on user narrative data. The user framework mapping circuitry 213 may utilize processor 202, memory 204, or any other hardware component included in the apparatus 200 to perform these operations, as described in connection with FIGS. 3-11 below. The user framework mapping circuitry 213 may further utilize communications hardware 206 to gather data from a variety of sources (e.g., user device(s) 106A-106N, entity devices 108A, 108N, storage device 103, content library 105, product and service database 107, and/or data sources 109, as shown in FIG. 1A).

In some embodiments, user framework mapping circuitry 213 may determine a POU alignment dataset by mapping features of user narrative data to predefined categories of a POU taxonomy using a trained model. In some embodiments, hyper-personalization system 102 may store (e.g., in memory 204, storage device 103, or the like) a POU taxonomy that maps predefined core values to a core values category, predefined aspirations to an aspirations category, and predefined pain points to a predefined pain points category. As one example, a predefined core value of “family” may map to the core values category, a predefined aspiration of “social impact” may map to the aspirations category, and a predefined paint point of “access to capital” may map to the pain points category.

In some embodiments, user framework mapping circuitry 213 may receive (e.g., from narrative processing engine 208) generated or derived text from user narrative data along with a determined emotion category (as discussed above). In some embodiments, user framework mapping circuitry 213 may then utilize a contextual embedding model (e.g., Sentence-BERT or the like) to process the text to determine a POU alignment dataset for the user. In some embodiments, user framework mapping circuitry 213 may provide the user narrative data as input to the model, which then encodes the text into an embedding vector along with predefined categories of a pillars of understanding (POU) taxonomy. In some embodiments, the model may determine cosine similarity between the predefined categories and elements of the user narrative and output a set of predefined core values, aspirations, and pain points which correspond to user core values, aspirations, and pain points mentioned by the user. In some embodiments, this output may comprise a POU alignment dataset comprising a core values dataset, an aspirations dataset, and a pain points dataset. As one example, a user may mention “taking care of my parents” and user framework mapping circuitry 213 may infer a core value of “family” as being important to the user. In some embodiments, the model may assign importance scores to a number of predefined core values, aspirations, and pain points which serve to rank the core values from most important to least important, the aspirations from most important to least important, and the pain points from most important to least important, based on the user narrative data provided by the user.

In some embodiments, the modeling engine 210 comprises archetype determination circuitry 214 that determines an archetype dataset for a user based at least on a portion of a POU alignment dataset. The archetype determination circuitry 214 may utilize processor 202, memory 204, or any other hardware component included in the apparatus 200 to perform these operations, as described in connection with FIGS. 3-11 below. The archetype determination circuitry 214 may further utilize communications hardware 206 to gather data from a variety of sources (e.g., user device(s) 106A-106N, entity devices 108A, 108N, storage device 103, content library 105, product and service database 107, and/or data sources 109, as shown in FIG. 1A).

In some embodiments, archetype determination circuitry 214 may assign a user to a predefined money behavior archetype based on the POU alignment dataset determined for the user. Example archetypes include a build security archetype, a gain freedom archetype, a support family archetype, a grow wealth archetype, and a mitigate stressors archetype. While these five archetypes are discussed herein, it is to be appreciated that additional archetypes may be utilized in some embodiments. In some embodiments, hyper-personalization system 102 may store (e.g., in memory 204, storage device 103, or the like) an archetype taxonomy that maps predefined core values, aspirations, and pain points to predefined archetype datasets. Additionally, each archetype dataset of the taxonomy may also define at least (i) a messaging tone, (ii) an engagement frequency, (iii) a sequence of offerings, and (iv) an engagement method, which can be used to inform empathic AI engine 215 and/or empathic agent circuitry 216 as to the manner in which a user that aligns with a certain archetype dataset should be engaged. In some embodiments, data contained in the archetype taxonomy may be used as training data to train various models used by hyper-personalization system 102, such as models used by modeling engine 210.

In some embodiments, archetype determination circuitry 214 may utilize a trained classifier model (e.g., a logistic regression model) to determine an archetype dataset for a user. The classifier model may be trained such that the model learns patterns with respect to core values, aspirations, and pain points and archetype labels. For example, the classifier model may be trained in a supervised manner using training samples (based on the archetype taxonomy) that include particular predefined core values, aspirations, and pain points along with a labeled money behavior archetype representing those predefined core values, aspirations, and pain points. Once the classifier model is trained, archetype determination circuitry 214 may provide a POU alignment dataset for a user to the classifier model as input, which is then processed by the classifier model. As a result of the processing, the classifier model may output a determined archetype dataset for the user (which corresponds to a predefined archetype dataset as defined by the archetype taxonomy). In some embodiments, the classifier model may output probability scores for each archetype dataset, with the highest probability score attributed to the archetype dataset most likely to align with the user. In some embodiments, a determined archetype dataset may include multiple archetype datasets, or an ‘archetype mix’ for a user. For example, an archetype dataset may indicate a primary archetype and at least one secondary archetype.

In some embodiments, the modeling engine 210 comprises an empathic artificial intelligence (AI) engine 215 that performs various actions (discussed below) to generate dynamic and engaging digital experiences while demonstrating an understanding of user feelings, concerns, and motivations to foster trust and rapport with users. The empathic AI engine 215 may utilize processor 202, memory 204, or any other hardware component included in the apparatus 200 to perform these operations, as described below and in connection with FIGS. 3-11. The empathic AI engine 215 may further utilize communications hardware 206 to gather data from a variety of sources (e.g., user device(s) 106A-106N, entity devices 108A, 108N, storage device 103, content library 105, product and service database 107, and/or data sources 109, as shown in FIG. 1A), and/or exchange data with a user.

In some embodiments, empathic AI engine 215 may receive inputs from other components of hyper-personalization system 102 such as, for example, user narrative data from narrative processing engine 208, a POU alignment dataset from user framework mapping circuitry 213, an archetype dataset from archetype determination circuitry 214, various instructions from personalized output generation engine 212, and the like. In some embodiments, empathic AI engine 215 may comprise a generative AI model, such as a large language model (LLM) to detect intent and emotion in text provided by users and provide conversational responses and prompts to users via, e.g., a hyper-personalized GUI. In various embodiments, empathic AI engine 215 may leverage model outputs from narrative processing engine 208 to identify emotion in audio or video provided by users and use the identified emotion as a basis for generating messages to users.

In some embodiments, empathic AI engine 215 may comprise several layers which includes various components directed to different functions of empathic AI engine 215. In some embodiments, empathic AI engine 215 may comprise one or more transformer layers that maintain context of historical interactions and/or sessions with users, including POU alignment datasets and archetype datasets for those users, as well as their historical emotional states and current emotional state. In some embodiments, empathic AI engine 215 may comprise a generative layer that includes an LLM which converses with a user via a hyper-personalized GUI and generates messages for users that include empathic personalized guidance, motivational reminders, suggestions, and the like. In some embodiments, empathic AI engine 215 may direct the LLM to generate messages by prompting the LLM with context about the user, including for example, a POU alignment dataset and archetype dataset for the user, current emotional state information, etc. In some embodiments, empathic AI engine 215 may comprise a content layer that identifies relevant content (e.g., of content library 105) or products and services (e.g., of product and service database 107) based on data about the user, their emotional state, their POU alignment dataset, archetype dataset, and/or the like. For example, the content layer may perform semantic comparisons between data about the user, their emotional state, their POU alignment dataset, and/or their archetype dataset with metadata of content in content library 105 and/or product and service database 107.

In some embodiments, the modeling engine 210 comprises empathic agent circuitry 216 that manages empathic AI agents that embody a role tailored to particular context of a user (e.g., a user's POU alignment dataset, archetype dataset, and/or the like). The empathic agent circuitry 216 may utilize processor 202, memory 204, or any other hardware component included in the apparatus 200 to perform these operations, as described in connection with FIGS. 3-11 below. The empathic agent circuitry 216 may further utilize communications hardware 206 to gather data from a variety of sources (e.g., user device(s) 106A-106N, entity devices 108A, 108N, storage device 103, content library 105, product and service database 107, and/or data sources 109, as shown in FIG. 1A), and/or exchange data with a user.

In some embodiments, empathic agent circuitry 216 may serve as an orchestration layer of empathic AI engine 215 that facilitates conversations with users and delegates and manages the workflow of each technical component of the empathic AI engine 215. In some embodiments, empathic agent circuitry 216 may simplify complex tasks including prompt chaining, interfacing with application programming interfaces (APIs), fetching contextual data, and managing memory across multiple LLM interactions. In various embodiments, empathic agent circuitry 216 may manages empathic AI agents that embody a role tailored to particular context of a user based on their POU alignment dataset and/or archetype dataset. For example, some example empathic AI agents may include a strategic protector agent that addresses anxieties and concerns related to financial security, a growth catalyst agent that motivates and encourages users to achieve financial aspirations, a legacy architect agent that helps users plan for the future and protect loved ones, and an encourager agent that provides ongoing support and guidance with empathy through encouragement along a financial experience. While these four agents are discussed herein, it is to be appreciated that additional agents may be utilized in some embodiments. In some embodiments, each empathic agent may be an LLM instance with distinct styles of communication and interaction (e.g., distinct tone, use of punctuation or grammar, etc.). In some embodiments, empathic agent circuitry 216 may orchestrate use of empathic AI agents, pass control of a conversation between agents, and the like.

Returning to FIG. 2A, in addition, the apparatus 200 further comprises a personalized output generation engine 212 that generates hyper-personalized graphical user interfaces (GUIs) and performs action sets in connection with a hyper-personalized GUI and/or user interactions. The personalized output generation engine 212 may utilize processor 202, memory 204, or any other hardware component included in the apparatus 200 to perform these operations, as described in connection with FIGS. 3-11 below. The personalized output generation engine 212 may further utilize communications hardware 206 to gather data from a variety of sources (e.g., user device(s) 106A-106N, entity devices 108A, 108N, storage device 103, content library 105, product and service database 107, and/or data sources 109, as shown in FIG. 1A), and/or exchange data with a user.

In some embodiments, personalized output generation engine 212 may dynamically generate personalized interfaces (e.g., hyper-personalized GUIs) based on user data, such as POU alignment datasets, archetype datasets, inferred emotion, demographic data, etc. In some embodiments, personalized output generation engine 212 may leverage GUI templates or schemas that define GUI layouts and components and modify the schemas based on user data to create a hyper-personalized GUI. In some embodiments, personalized output generation engine 212 may dynamically modify a hyper-personalized GUI in real-time based on inputs received from user (e.g., via their user device 106A). For example, in some embodiments, a user may respond to a message (e.g., a message generated by empathic AI engine 215) and personalized output generation engine 212 may dynamically modify a portion of the hyper-personalized GUI based on the response. For example, a user may request information about certain content, and in response, personalized output generation engine 212 may retrieve the content (e.g., from content library 105) and present it in a manner that aligns with their POU alignment dataset, archetype dataset, and/or the like. In this regard, the content may be presented alongside a message generated by empathic AI engine 215 that explains the content in a certain way (e.g., using a particular empathic AI agent).

In some embodiments, personalized output generation engine 212 may serve as an orchestrator for hyper-personalization system 102 by directing various components of hyper-personalization system 102 to perform action sets (e.g., one or more actions) based on user interactions (e.g., interactions with a hyper-personalized GUI or more generally any user input provided to hyper-personalization system 102). For example, personalized output generation engine 212 may direct any one of narrative processing engine 208, modeling engine 210, user framework mapping circuitry 213, archetype determination circuitry 214, empathic AI engine 215, and empathic agent circuitry 216 to perform one or more actions. In turn, personalized output generation engine 212 may receive output of those actions from the component that performed the action and generate or modify hyper-personalized GUI based on the output.

Although components 202-216 are described in part using functional language, it will be understood that the particular implementations necessarily include the use of particular hardware. It should also be understood that certain of these components 202-216 may include similar or common hardware. For example, the narrative processing engine 208, modeling engine 210, personalized output generation engine 212, user framework mapping circuitry 213, archetype determination circuitry 214, empathic AI engine 215, and empathic agent circuitry 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the narrative processing engine 208, modeling engine 210, personalized output generation engine 212, user framework mapping circuitry 213, archetype determination circuitry 214, empathic AI engine 215, and empathic agent circuitry 216 may leverage processor 202, memory 204, or communications hardware 206 as described above, it will be understood that any of narrative processing engine 208, modeling engine 210, personalized output generation engine 212, user framework mapping circuitry 213, archetype determination circuitry 214, empathic AI engine 215, and empathic agent circuitry 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the narrative processing engine 208, modeling engine 210, personalized output generation engine 212, user framework mapping circuitry 213, archetype determination circuitry 214, empathic AI engine 215, and empathic agent circuitry 216 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIGS. 2A and 2B, that loading the software instructions onto a computing device or apparatus produces a special-purpose machine comprising the means for implementing various functions described herein.

Having described specific components of example apparatus 200, example embodiments are described below in connection with a series of flowcharts and graphical user interfaces.

### Example Operations

Turning to FIGS. 3-11, example flowcharts are illustrated that contain example operations implemented by example embodiments described herein. The operations illustrated in FIGS. 3-11 may, for example, be performed by system device 101 of the hyper-personalization system 102 shown in FIG. 1A, which may in turn be embodied by an apparatus 200, which is shown and described in connection with FIGS. 2A and 2B. To perform the operations described below, the apparatus 200 may utilize one or more of processor 202, memory 204, communications hardware 206, the narrative processing engine 208, modeling engine 210, personalized output generation engine 212, user framework mapping circuitry 213, archetype determination circuitry 214, empathic AI engine 215, empathic agent circuitry 216, and/or any combination thereof. It will be understood that in some embodiments user interaction with the hyper-personalization system 102 may occur directly via communications hardware 206 or may instead be facilitated by a separate user device (e.g., any of user devices 106A-106N), as described above in connection with FIGS. 1A and 1B, and which may have similar or equivalent physical componentry facilitating such user interaction.

Turning first to FIG. 3, example operations are shown for hyper-personalizing digital actions and interfaces.

In some embodiments, a user may leverage a mobile application (e.g., system application 112) for financial planning and/or assistance to streamline and manage their financial lives more efficiently. Such a mobile application may be, for example, a mobile banking application or component of a mobile banking application offered by a financial institution to customers. A user may install the mobile application (e.g., shown as system application 112 in FIG. 1B) on their personal user device (user device 106A, for example) in order to access and use various features provided by the mobile application. In various embodiments, the mobile application may provide advice to users in the form of advice lists. An advice list may comprise a series of prioritized steps to take in order for a user to achieve a goal (e.g., a financial or personal goal) defined or selected by the user via the mobile application. Such advice may include for example, saving a certain amount of money per month, reading a certain book to learn more about personal finance, investing in an educational savings account for one or more children, paying off certain debt ahead of other debt, re-financing a loan, and/or the like. The mobile application may provide a series of electronic interfaces (e.g., graphical user interfaces (GUIs)) that allow for users to efficiently and effectively manage financial goals and stay up to date on their financial lives. In general, the mobile application digital experience may be delivered at least in part by the hyper-personalization system 102 shown in FIG. 1A.

As shown by operation 302, the apparatus 200 includes means, such as processor 202, memory 204, communications hardware 206, or the like, for receiving user narrative data associated with a user.

In some embodiments, user narrative data may be received via communications hardware 206 from a user device 106A over communications network 104. For example, in some embodiments, user narrative data may be generated at a user device 106A in response to a user submitting information to the mobile application (e.g., system application 112). In some embodiments, user narrative data may be generated at a user device 106A in response to a user submitting information via another channel, such as a web page or separate application associated with the mobile application and/or financial institution that manages the mobile application.

In some embodiments, user narrative data may be generated at a user device 106A in response to a conversational prompt generated by hyper-personalization system 102. For example, in some embodiments, empathic AI engine 215 and/or empathic agent circuitry 216 may generate a prompt in the form of a question directed to a user in response to the user logging into the mobile application, web page or the like and/or interacting with one or more UI elements of the mobile application. In some embodiments, user narrative data may comprise free text provided at the user's will (e.g., not provided in response to a generated question or prompt).

In some embodiments, at least a portion of user narrative data may be received in response to completing (e.g., responding or providing inputs to) a digital survey that prompts questions to the user via one electronic interfaces of the mobile application. In this regard, the apparatus 200 includes means, such as processor 202, memory 204, communications hardware 206, or the like, for causing presentation of a digital survey at a client device of the first user. In some embodiments, the digital survey may comprise one or more of multiple-choice questions, rating scale questions, short answer questions (e.g., free text entry), dropdown questions (e.g., selecting an answer from a dropdown box), rating scale questions, and the like. By answering these questions, a user may provide self-identifying information about their demographics, personal background, culture, state of mind, beliefs, stances, values, preferences, and generally what is important to them. In some embodiments, full completion (e.g., answering every question) may be voluntary such that the user may only answer questions they are comfortable with answering.

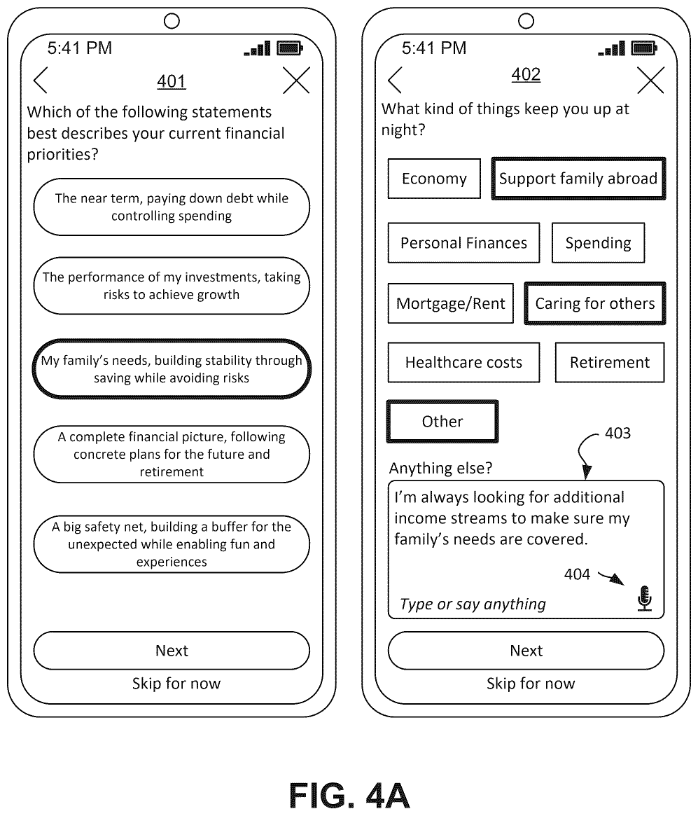

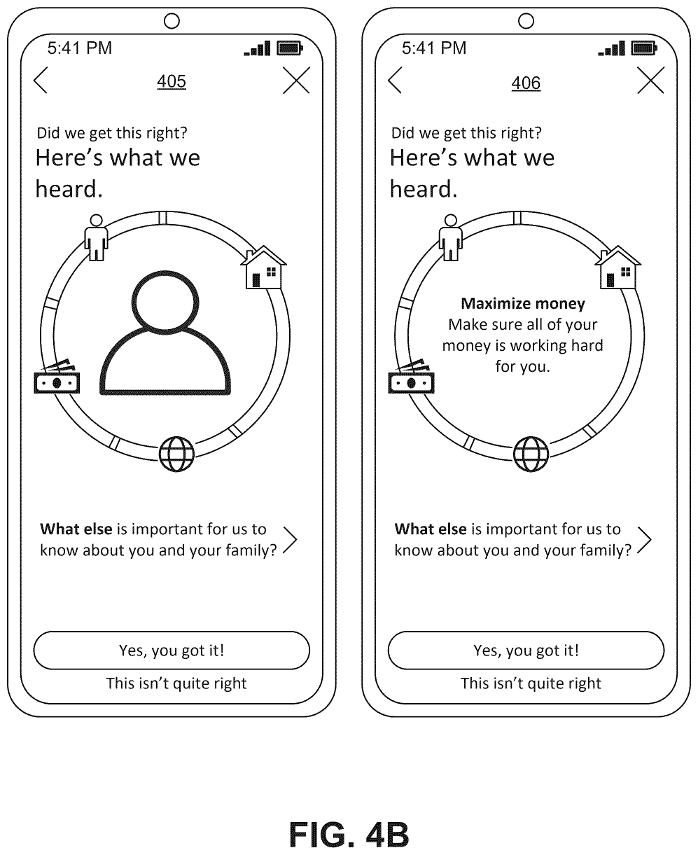

In some embodiments, a digital survey may be presented as a part of onboarding a user into the hyper-personalization system 102 such that a hyper-personalized GUI and digital experience may be generated for the user. FIG. 4A shows an example of a digital survey presented as part of onboarding. For example, in some embodiments, a user may be presented with a first screen 401 (e.g., via system application 112 on their personal user device 106A) that prompts a first question and enables the user to interactively select one or more answers to the question. In response to selecting the next button, a second screen 402 may be presented to the user. The second screen 402 may prompt a second question to the user and enable the user to interactively select one or more answers to the second question. Additionally, a free text box 403 may be displayed that allows the user to type free text and submit the free text as additional user narrative data. In some embodiments, the user may select the microphone button 404 to input their answer as audio using a microphone on their user device 106A, which can be converted into text and populated in free text box 403. Though not explicitly shown in FIG. 4A, in some embodiments, a user may also submit an audio and/or video file as additional user narrative data, which may then be further processed by narrative processing engine 208.

In some embodiments, some user narrative data may be received as part of onboarding, as mentioned above. For example, in some embodiments, the onboarding may comprise asking the questions shown in FIG. 4A. In response to answering the questions, hyper-personalization system 102 may process the user narrative data provided in response to the onboarding process (e.g., through performing operations 304 and 306 shown in FIG. 3 and further described below) and provide one or more example confirmation screens as shown in FIG. 4B. As shown, a first confirmation screen 405 and a second confirmation screen 406 may prompt the user to confirm whether the information they provided was properly assessed by the hyper-personalization system 102. Additionally, in some embodiments and as shown in FIG. 4B, the confirmation screens may also enable the user to enter additional user narrative data.

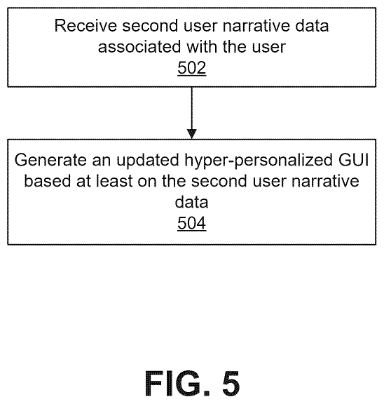

In some embodiments, the collection of user narrative data may be a continuous process, wherein hyper-personalization system 102 continuously prompts the user with certain questions over time (e.g., outside of an initial onboarding stage), and/or enables a user to submit additional user narrative data on their own (e.g., without being prompted) in order to generate or modify a hyper-personalized digital experience for the user. Turning briefly to FIG. 5, example operations are shown for continuously collecting user narrative data.

As shown by operation 502, the apparatus 200 includes means, such as processor 202, memory 204, communications hardware 206, or the like, for receiving second user narrative data associated with the user. In some embodiments, second user narrative data associated with the user may be received after presentation of the hyper-personalized GUI at a user device (discussed further below), for example, after determining a POU alignment dataset and archetype dataset for the user.

As shown by operation 504, the apparatus 200 includes means, such as processor 202, memory 204, communications hardware 206, personalized output generation engine 212, and/or the like, for generating an updated hyper-personalized GUI based at least on the second user narrative data. For example, in some embodiments, generating an updated hyper-personalized GUI based at least on the second user narrative data may comprise determining an updated POU alignment dataset. In this regard, personalized output generation engine 212 may direct narrative processing engine 208 to process the second user narrative data (e.g., providing the second user narrative data to extract features for use in determining an updated POU alignment dataset for the user. The narrative processing engine 208 may then provide its output (e.g., extracted features) to user framework mapping circuitry 213, which may then provide the output as input to the contextual embedding model to determine an updated POU alignment dataset for the user, which may comprise at least one of an updated core values dataset, an aspirations dataset, and a pain points dataset. In some embodiments, based on determining an updated POU alignment dataset based on the second user narrative data, user framework mapping circuitry 213 may provide the updated POU alignment dataset to archetype determination circuitry 214, which may then determine an updated archetype dataset for the user based on the updated POU alignment dataset. In this regard, in some embodiments, generating an updated hyper-personalized GUI based at least on the second user narrative data may also comprise determining an updated archetype dataset for the user. In some embodiments, by generating an updated POU alignment dataset and/or an updated archetype dataset, the personalized output generation engine 212 may generate an updated hyper-personalized GUI that presents content, messages, images, and/or the like in a different manner than an initial hyper-personalized GUI generated for the user (e.g., a hyper-personalized GUI generated prior to receiving the second user narrative data).

Returning to FIG. 3, as shown by operation 304, the apparatus 200 includes means, such as processor 202, memory 204, communications hardware 206, modeling engine 210, user framework mapping circuitry 213, and/or the like, for determining a pillars of understanding (POU) alignment dataset for the user based at least on the user narrative data.

In various embodiments, hyper-personalization system 102 may receive user narrative data via communications hardware 206 from a user device 106A over communications network 104, and the user narrative data may subsequently be processed using narrative processing engine 208 to generate text (e.g., in situations where the user narrative data comprises audio and/or video) and/or determine a feature set as discussed above. Output of narrative processing engine 208 (e.g., generated text and/or a derived feature set) may then be provided to user framework mapping circuitry 213 of modeling engine 210 to determine a POU alignment dataset for the user.

In some embodiments, user framework mapping circuitry 213 of modeling engine 210 may determine a POU alignment dataset by mapping features of user narrative data (e.g., of the feature set) to predefined categories of a POU taxonomy using, e.g., a contextual embedding model to process the text to determine a POU alignment dataset for the user. In some embodiments, user framework mapping circuitry 213 may provide the user narrative data (e.g., feature set) as input to the model, which then encodes the text into an embedding vector along with predefined categories of POU taxonomy.

In some embodiments, the contextual embedding model may determine cosine similarity between the predefined categories and elements of the input user narrative and output a set of predefined core values, aspirations, and pain points which correspond to user core values, aspirations, and pain points mentioned by the user. In some embodiments, this output may comprise a POU alignment dataset comprising a core values dataset, an aspirations dataset, and a pain points dataset. As an example (shown in FIG. 4A), based on a user mentioning “looking for additional income streams,” user framework mapping circuitry 213 may infer, using the model, a pain point of “access to capital” for the user, and based on the user mentioning “make sure my family's needs are covered,” and/or selecting “support family abroad” answer button, user framework mapping circuitry 213 may infer, using the model, a core value of “family” for the user. Additionally, by selecting the answer button that includes “building stability through saving while avoiding risks,” user framework mapping circuitry 213 may infer, using the model, aspirations of “legacy protection” and “peace of mind” for the user. In some embodiments, the model may assign importance scores to a number of predefined core values, aspirations, and pain points which serve to rank the core values from most important to least important, the aspirations from most important to least important, and the pain points from most important to least important, based on the user narrative data provided by the user.

In some embodiments, a POU alignment dataset may comprise a plurality of datasets that indicate various information about the user. These datasets may include a core values dataset, an aspirations dataset, and a pain points dataset. In some embodiments, a POU alignment dataset may be determined in response to receiving user narrative data about the user.

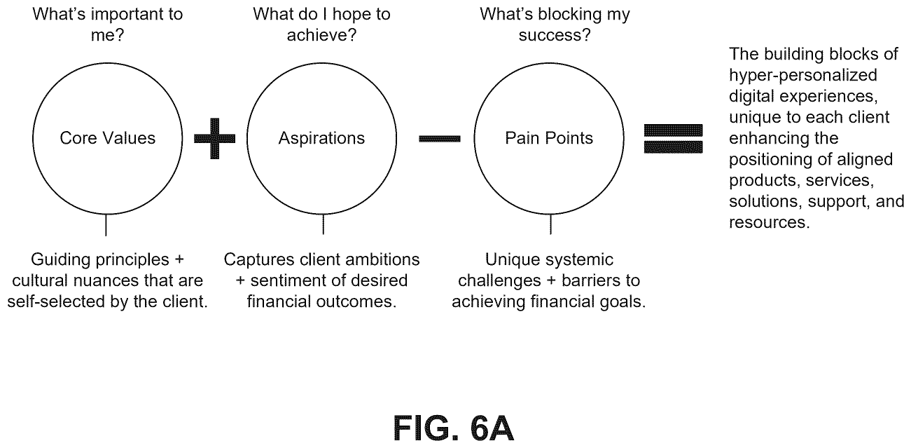

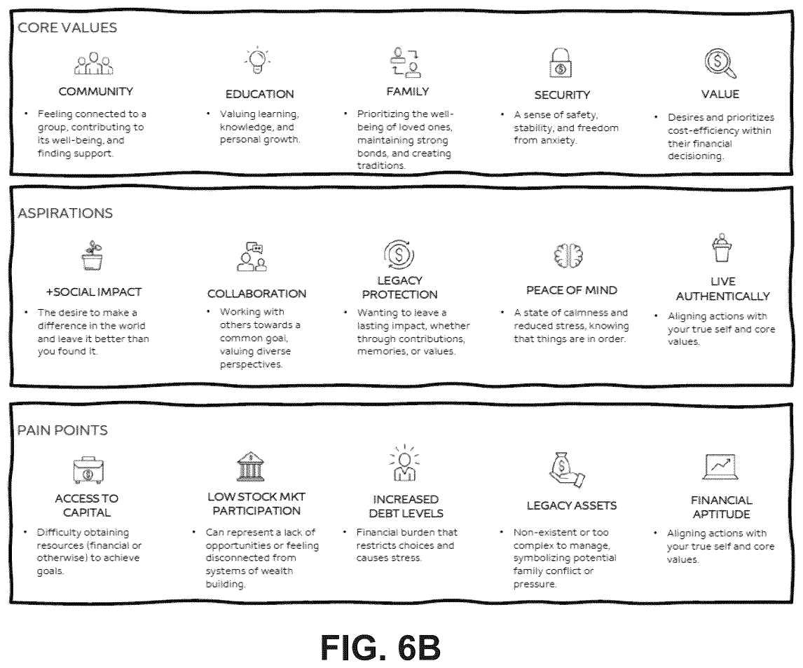

As noted above, a POU alignment dataset may comprise a plurality of datasets including a core values dataset, an aspirations dataset, and a pain points dataset. In various embodiments, core values, aspirations, and pain points may serve as pillars of understanding a user and in turn creating a hyper-personalized digital experience unique to the user. Turning briefly to FIGS. 6A and 6B, visual representations of these three datasets is provided.

In some embodiments, a POU alignment dataset may comprise a core values dataset that contains information regarding what a user regards as their core values (e.g., answers to the question ‘what's important to me?’). Core values may include guiding principles and cultural nuances that are self-selected by a user or inferred from user narrative data provided by the user.

As shown in FIG. 6B, some example predefined core values may include, for example, community (e.g., feeling connected to a group, contributing to its well-being, and finding support), education (e.g., valuing learning, knowledge, and personal growth), family (e.g., prioritizing the well-being of loved ones, maintaining strong bonds, and creating traditions), security (e.g., a sense of safety, stability, and freedom from anxiety), and value (e.g., prioritizing what matters most and aligning decisions with personal beliefs). In various embodiments, a core values dataset may indicate one or more of these core values. It is to be appreciated that other predefined core values (in addition to the ones mentioned above) may be utilized in some embodiments.

In some embodiments, a POU alignment dataset may comprise an aspirations dataset that contains information regarding what a user hopes to achieve. Aspirations may include user ambitions and sentiment of desired financial outcomes. As shown in FIG. 6B, some example predefined aspirations may include, for example, social impact (e.g., a desire to make a difference in the world and leave it better then you found it), collaboration (e.g., working with others towards a common goal and valuing diverse perspectives), legacy protection (e.g., wanting to leave a lasting impact, whether through contributions, memories, or values), peace of mind (e.g., achieving a state of calmness and reduced stress, knowing that things are in order), and authentic living (e.g., aligning actions with one's true self and core values). In some embodiments, an aspirations dataset may indicate one or more of these aspirations. It is to be appreciated that other predefined aspirations (in addition to the ones mentioned above) may be utilized in some embodiments.

In some embodiments, a POU alignment dataset may comprise a pain points dataset that contains information regarding unique systemic challenge and barriers to achieving financial goals. As shown in FIG. 6B, some example predefined pain points may include, for example, access to capital (e.g., difficulty obtaining resources (financial or otherwise) to achieve goals), low stock market participation (e.g., a lack of opportunities or feeling disconnected from systems of wealth building), increased debt levels (e.g., financial burden that restricts choices and causes stress), legacy assets (e.g., non-existent or too complex to manage, symbolizing potential family conflict or pressure), and financial aptitude (e.g., a lack of knowledge about money management creating uncertainty and vulnerability. In various embodiments, a pain points values dataset may indicate one or more of these pain points. It is to be appreciated that other predefined pain points (in addition to the ones mentioned above) may be utilized in some embodiments.

As shown by operation 306, the apparatus 200 includes means, such as processor 202, memory 204, modeling engine 210, archetype determination circuitry 214, and/or the like, for determining an archetype dataset for the user based at least on a portion of the POU alignment dataset. In some embodiments, as discussed above, archetype determination circuitry 214 may assign a user to a predefined money behavior archetype based on the POU alignment dataset determined for the user.

Some example predefined archetypes include a build security archetype, a gain freedom archetype, a support family archetype, a grow wealth archetype, and a mitigate stressors archetype. In some embodiments, hyper-personalization system 102 may store (e.g., in memory 204, storage device 103, or the like) an archetype taxonomy that maps predefined core values, aspirations, and pain points to predefined archetype datasets. Additionally, each archetype dataset of the taxonomy may also define at least a messaging tone, an engagement frequency, a sequence of offerings, and an engagement method, each of which can be used to inform empathic AI engine 215 and/or empathic agent circuitry 216 as to the manner in which a user that aligns with a certain archetype dataset should be engaged.

In some embodiments, a messaging tone may indicate a tone of voice to be used when communicating with a user. For example, the messaging tone that corresponds with a user's archetype dataset may be provided to empathic AI engine 215 such that messages generated by empathic AI engine 215 and/or empathic AI agents selected for use in communicating with the user align with the messaging tone. In some embodiments, an engagement frequency may indicate how often to engage a user with respect to communications to the user (e.g., from AI engine 215 and/or empathic agent circuitry 216, from human service agents (e.g., customer service agents of a financial institution, financial advisors, etc.), and/or the like). In some embodiments, a sequence of offerings may indicate which products and/or services to surface and present (e.g., via a hyper-personalized GUI) and in what order to present the products and/or services (e.g., a prioritization of products and/or services). In some embodiments, an engagement method may indicate whether the user likely desires to be engaged in a digital manner or a human manner. For example, an engagement method may specify a preference for digital communications (e.g., messages from empathic AI engine 215) or human-directed outreach (e.g., phone calls, in-person meetings with human agents, etc.).

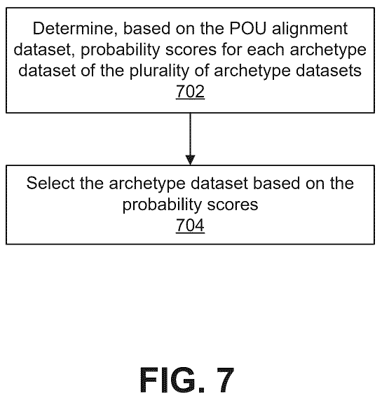

Turning briefly to FIG. 7, example operations are shown for determining an archetype dataset for the user based at least on a portion of the POU alignment dataset. In some embodiments, the archetype dataset for the user is determined based on the core values dataset and the aspirations dataset of a POU alignment dataset.

In some embodiments, archetype determination circuitry 214 may utilize a trained classifier model to determine an archetype dataset for a user. The classifier model may be trained such that the model learns the archetype taxonomy and patterns with respect to core values, aspirations, and pain points and archetype labels. In this regard, the apparatus 200 includes means, such as processor 202, memory 204, archetype determination circuitry 214, and/or the like, for processing the POU alignment dataset using a trained classifier model, the trained classifier model having been trained using at least an archetype taxonomy.

In some embodiments, archetype determination circuitry 214 may provide a POU alignment dataset for a user to the classifier model as input, which is then processed by the classifier model. As shown by operation 702, in processing the POU alignment dataset, the apparatus 200 includes means, such as processor 202, memory 204, archetype determination circuitry 214, and/or the like, for determining, based on the POU alignment dataset, probability scores for each archetype dataset of the plurality of archetype datasets. In some embodiments, the classifier model may assign probability scores to each archetype dataset based on how closely they align with the core values and aspirations included in the POU alignment dataset. As shown by operation 704, in processing the POU alignment dataset, the apparatus 200 includes means, such as processor 202, memory 204, archetype determination circuitry 214, and/or the like, for selecting the archetype dataset based on the probability scores. For example, archetype determination circuitry 214 may select the archetype dataset having the highest probability score among the plurality of archetype datasets. As a result of the processing, the classifier model may output a determined archetype dataset for the user that corresponds to a predefined archetype dataset as defined by the archetype taxonomy. In some embodiments, the classifier model may output probability scores for each archetype dataset, with the highest probability score attributed to the archetype dataset most likely to align with the user.

As shown by operation 308, the apparatus 200 includes means, such as processor 202, memory 204, communications hardware 206, personalized output generation engine 212, and/or the like, for generating a hyper-personalized graphical user interface (GUI) based on the POU alignment dataset and the archetype dataset. In some embodiments, personalized output generation engine 212 may dynamically a generate hyper-personalized GUIs based on user data, such as a POU alignment dataset, an archetype dataset, emotion data, customer data, and the like. For example, for a given user, personalized output generation engine 212 may receive a POU alignment dataset and archetype dataset as determined by user framework mapping circuitry 213 and archetype determination circuitry 214 as discussed above. In some embodiments, personalized output generation engine 212 may receive emotion data from narrative processing engine 208 that indicates a current emotion the user is experiencing, based on user narrative data submitted to hyper-personalization system 102. For example, as discussed above, in some embodiments, narrative processing engine 208 may process audio or video to detect user sentiment, mood, and/or the like.

In some example embodiments, hyper-personalization system 102 may leverage one or more hardware components of a user device 106A to obtain emotion data. For example, hyper-personalization system 102 may leverage a camera of the user device 106A to obtain a video or image of the user, based on permissions configured by the user for system application 112 on their user device 106A.

In some embodiments, hyper-personalization system 102 may also retrieve additional customer data about the user to further personalize digital actions and interfaces for the user. For example, hyper-personalization system 102 may utilize communications hardware 206 to query a system of record or similar data source (e.g., of data sources 109) and obtain customer data regarding the user. For example, the user may be a pre-existing customer of a financial institution, and customer data may include various identifying information about the user (e.g., name, address, age, background, interests, etc.), historical interactions with the financial institution, system application 112, and/or the like.

In some embodiments, to generate a hyper-personalized GUI, personalized output generation engine 212 may retrieve GUI templates or schemas (e.g., from memory 204, storage device 103, and/or the like) that define GUI layouts and components and modify the schemas based on the user data to create a hyper-personalized GUI. Additionally, personalized output generation engine 212 may direct other components of hyper-personalization system 102 to generate content to be included in the hyper-personalized GUI, e.g., by sending instructions to the components. For example, personalized output generation engine 212 may generate a hyper-personalized GUI that includes one or more messages generated by empathic AI engine 215, e.g., in accordance with the messaging tone corresponding to the determined archetype dataset for the user.

As another example, in some embodiments, personalized output generation engine 212 may generate a hyper-personalized GUI that includes suggested content based on the POU alignment dataset or the archetype dataset for the user. For example, personalized output generation engine 212 may retrieve, via communications hardware 206, content from content library 105 by querying content library 105 using information contained in a POU alignment dataset or the archetype dataset. Content retrieved may be tagged with metadata that corresponds to core values, aspirations, and/or pain points indicated by the POU alignment dataset or the archetype indicated by the archetype dataset, for example.

In some embodiments, personalized output generation engine 212 may generate a hyper-personalized GUI that includes images, text, video, audio, and/or other media that align with core values, aspirations, and/or pain points indicated by the POU alignment dataset and/or the archetype indicated by the archetype dataset. For example, a user aligned with the grow wealth archetype may be presented with additional charts and trend data in their hyper-personalized GUI when compared with users who align with other archetypes. In some embodiments, personalized output generation engine 212 may generate a hyper-personalized GUI that includes images, text, video, audio, and/or other media that align with demographic and/or cultural data of a user based on customer data (e.g., user-provided self-identifying information, such as age, generation, gender, preferences, culture, race, etc.).

As shown by operation 310, the apparatus 200 includes means, such as processor 202, memory 204, communications hardware 206, personalized output generation engine 212, and/or the like, for causing presentation of the hyper-personalized GUI at a user device associated with the user. In some embodiments, personalized output generation engine 212 may direct communications hardware 206 to cause transmission of data to user device 106A such that user device 106A may visually display the hyper-personalized GUI at user device 106A via system application 112.

As shown by operation 312, the apparatus 200 includes means, such as processor 202, memory 204, communications hardware 206, personalized output generation engine 212, and/or the like, for performing, based on at least one of the POU alignment dataset and the archetype dataset, an action set in connection with one or more user interactions with the hyper-personalized GUI. In some embodiments, personalized output generation engine 212 may perform action sets by instructing various components of hyper-personalization system 102 to generate messages, content, and/or media to modify the hyper-personalized GUI in various manners. In some embodiments, personalized output generation engine 212 may perform action sets in response to certain events, user interactions, and/or the like.

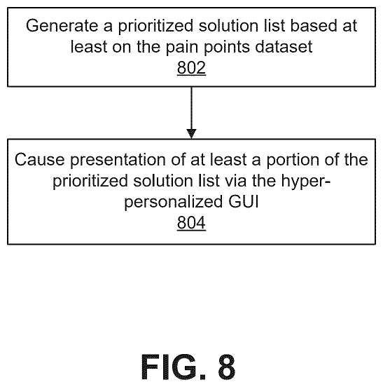

Turning to FIG. 8, in some embodiments, performing an action set may comprise prioritizing and surfacing relevant content to a user via the hyper-personalized GUI. As shown by operation 802, the apparatus 200 includes means, such as processor 202, memory 204, communications hardware 206, personalized output generation engine 212, and/or the like, for generating a prioritized solution list based at least on the pain points dataset.

In some embodiments, solution lists may be predefined based on one or more pain points indicated in a pain points dataset. For example, personalized output generation engine 212 may retrieve (e.g., from memory 204, storage device 103, and/or the like) a predefined solution set based on at least one pain point indicated in a pain points dataset. For example, personalized output generation engine 212 may retrieve a solution set based on metadata stored in association with the solution set that corresponds to one or more predefined pain points.

As shown by operation 804, the apparatus 200 includes means, such as processor 202, memory 204, communications hardware 206, and/or the like, for causing presentation of at least a portion of the prioritized solution list via the hyper-personalized GUI.

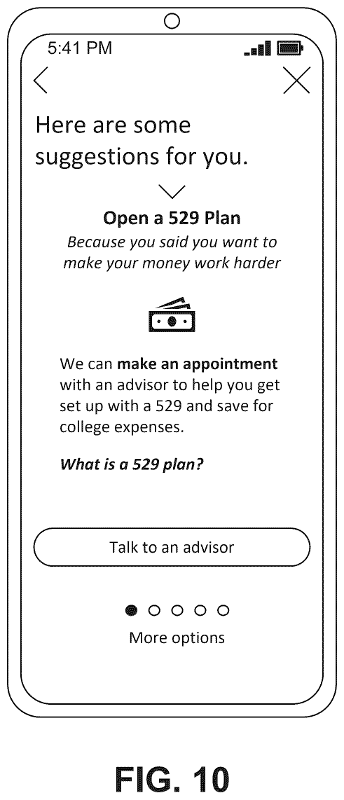

In some embodiments, a prioritized solution list may be presented in full via the hyper-personalized GUI. In some embodiments, portions of a prioritized solution list may be presented in part and/or at different times, depending on various factors. FIG. 10 shows an example GUI displaying a portion of a solution list. As shown, the example GUI presents one solution of a solution list (e.g., ‘Open a 529 Plan’), provides a reasoning for the solution (‘you want to make your money work harder’), as well as additional links to make an appointment with an advisor and provide more information about a 529 plan.

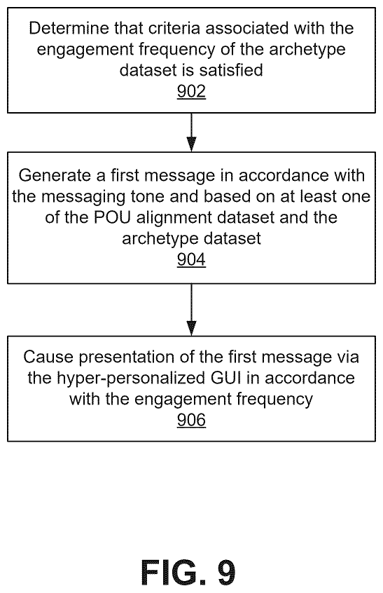

Turning to FIG. 9, in some embodiments, performing an action set may comprise generating empathic messages, recommendations, reminders, and/or other communications and delivering them through the hyper-personalized GUI.

As shown by operation 902, the apparatus 200 includes means, such as processor 202, memory 204, communications hardware 206, personalized output generation engine 212, and/or the like, for determining that criteria associated with the engagement frequency of the archetype dataset is satisfied. For example, in some embodiments, personalized output generation engine 212 may monitor user engagement and detect a time at which to engage the user via the hyper-personalized GUI. For example, based on an engagement frequency defined by the user's archetype dataset, personalized output generation engine 212 may detect that a predefined amount of time has passed since the user was last engaged (e.g., sent an empathic message, provided with a solution of a solution list, etc.) via the hyper-personalized GUI, and take action to re-engage with the user.

As shown by operation 904, the apparatus 200 includes means, such as processor 202, memory 204, communications hardware 206, modeling engine 210, and/or the like, for generating a first message in accordance with the messaging tone and based on at least one of the POU alignment dataset and the archetype dataset. For example, in response to determining that criteria associated with the engagement frequency of the archetype dataset is satisfied, in some embodiments, personalized output generation engine 212 may direct empathic AI engine 215 and/or empathic agent circuitry 216 to generate an empathic message in order to re-engage with the user via the hyper-personalized GUI. In this example, an empathic message may be generated in accordance with the messaging tone defined by the archetype dataset associated with the user. As shown by operation 906, the apparatus 200 includes means, such as processor 202, memory 204, communications hardware 206, and/or the like, for causing presentation of the first message via the hyper-personalized GUI in accordance with the engagement frequency.

In some embodiments, as discussed above, personalized output generation engine 212 may dynamically modify a hyper-personalized GUI in real-time based on inputs received from user (e.g., via their user device 106A). For example, in some embodiments, a user may respond to a message (e.g., a message generated by empathic AI engine 215) and personalized output generation engine 212 may dynamically modify a portion of the hyper-personalized GUI based on the response. For example, a user may request information about certain content, and in response, personalized output generation engine 212 may retrieve the content (e.g., from content library 105) and present it in a manner that aligns with their POU alignment dataset, archetype dataset, and/or the like. In this regard, the content may be presented alongside a message generated by empathic AI engine 215 that explains the content in a certain way (e.g., using a particular empathic AI agent).

In some embodiments, hyper-personalization system 102 may enable users such as financial advisors, bankers, and the like to interface with the hyper-personalization system 102 to gain insights into various user data collected and outputs produced by hyper-personalization system 102. In some embodiments, based on a wealth of data provided to hyper-personalization system 102, modeling engine may generate and store user profiles for users of hyper-personalization system 102. These user profiles may be continuously updated as the hyper-personalization system 102 receives new data regarding various users.

In some embodiments, user profiles may be stored (e.g., in storage device 103). An example user profile for a user may include customer data (e.g., user-provided self-identifying information, such as age, generation, gender, preferences, culture, race, etc.), POU alignment dataset, archetype dataset, historical data including historical emotion data, historical user interactions with hyper-personalization system 102 and/or system application 112 (e.g., user responses to empathic messages, etc.), and the like.

In some embodiments, an advisor (via an entity device 108A) may leverage hyper-personalization system 102 to obtain statistical data and other types of data regarding particular users and/or pluralities of users, in order to obtain a deep, data-driven understanding of unique financial motivators that drive certain users. In this regard, advisors may be equipped to discover underlying core values, aspirations, and pain points that drive financial decisions for certain users or demographics (e.g., age groups, generations, genders, cultural backgrounds, etc.). By doing so, advisors may be provided with a deeper understanding of their clients, learn methods of personalized engagement, optimize their prospecting strategies, and obtain a competitive advantage to attract new clients.

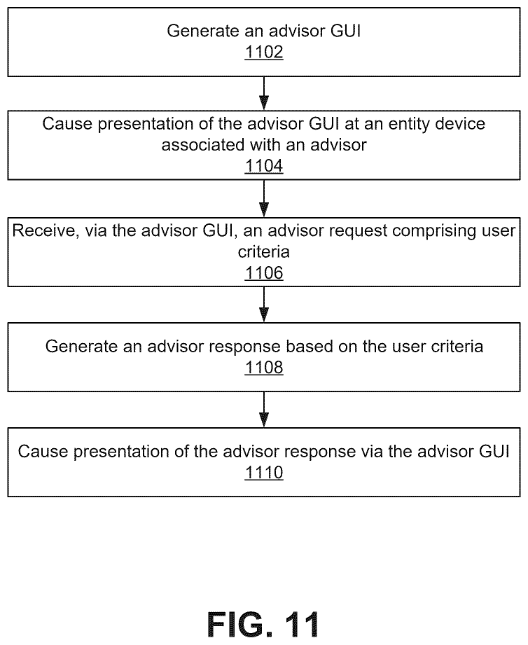

FIG. 11 illustrates example operations for providing responses to advisor requests via an advisor GUI.

As shown by operation 1102, the apparatus 200 includes means, such as processor 202, memory 204, communications hardware 206, personalized output generation engine 212, and/or the like, for generating an advisor GUI. In some embodiments, to generate an advisor GUI, personalized output generation engine 212 may retrieve GUI templates or schemas (e.g., from memory 204, storage device 103, and/or the like) that define GUI layouts and components for advisor GUIs and, in some embodiments, modify the schemas based on advisor data to create an advisor GUI tailored to a particular advisor. In this regard, an advisor GUI may be personalized for a specific advisor by including, for example, information about the advisor, their clients, and/or the like. Additionally, personalized output generation engine 212 may direct other components of hyper-personalization system 102 to generate content to be included in the advisor GUI, e.g., by sending instructions to the components. For example, personalized output generation engine 212 may generate an advisor GUI that includes one or more messages generated by empathic AI engine 215 (e.g., a message that asks the advisor what information they would like to know, a message that reminds the advisor about a client appointment or other matter, and/or the like).

As shown by operation 1104, the apparatus 200 includes means, such as processor 202, memory 204, communications hardware 206, and/or the like, for causing presentation of the advisor GUI at an entity device associated with an advisor. In some embodiments, personalized output generation engine 212 may direct communications hardware 206 to cause transmission of data to entity device 108A such that entity device 108A may visually display the advisor GUI at entity device 108A via system application 112.

As shown by operation 1106, the apparatus 200 includes means, such as processor 202, memory 204, communications hardware 206, and/or the like, for receiving, via the advisor GUI, an advisor request comprising user criteria. In various embodiments, an advisor request may be received via communications hardware 206 from an entity device 108A over communications network 104. For example, in some embodiments, an advisor request may be generated at an entity device 108A in response to a user (e.g., an advisor) submitting information to the mobile application (e.g., system application 112). In some embodiments, an advisor request may be generated at an entity device 108A in response to an advisor submitting information via another channel, such as a web page or separate application associated with the mobile application and/or financial institution that manages the mobile application.

In some embodiments, an advisor request may be generated at an entity device 108A in response to a conversational prompt generated by hyper-personalization system 102. For example, in some embodiments, empathic AI engine 215 and/or empathic agent circuitry 216 may generate a prompt in the form of a question directed to an advisor in response to the advisor logging into the mobile application, web page or the like and/or interacting with one or more UI elements of the mobile application. In some embodiments, an advisor request may comprise free text provided at the advisor's will (e.g., not provided in response to a generated question or prompt). As one example, empathic AI engine 215 and/or empathic agent circuitry 216 may generate a prompt asking the advisor what information they would like to know. In response, the advisor may interact conversationally by responding to the prompt. As some examples, the advisor may provide an advisor request of “show me typical core values of millennials between the ages of 38-42,” or “what is the best way to engage affluent men over the age of 50?,” or “what seems to be the most important core value for baby boomers?,” and the like. User criteria of an advisor request may comprise data about one or more particular users (e.g., name, a unique user identifier, etc.), data about a plurality of users in general (e.g., an age range, occupation, location

As shown by operation 1108, the apparatus 200 includes means, such as processor 202, memory 204, modeling engine 210, personalized output generation engine 212, and/or the like, for generating an advisor response based on the user criteria.

In various embodiments, personalized output generation engine 212 may provide the advisor request to the empathic AI engine 215, which may use the LLM to interpret the advisor request and generate a query based on the advisor request. The query may be executed over the stored user profiles (e.g., of storage device 103) in order to obtain relevant results related to the advisor request. The LLM may then process the results by aggregating the results and/or generating summarizations of the results and outputting the summarizations as an advisor response to the advisor request.

In some embodiments, in generating an advisor response, the LLM of empathic AI engine 215 may blend aggregated data into natural language narratives. This blending may be performed across a multitude of user profiles, such that data points may be blended together and interpreted to surface new insights regarding a user base to advisors. For example, advisor responses may indicate shared patterns, similarities, differences, pillars of understanding, archetypes, engagement preferences, sequence of offerings, and/or the like between users of differing cultural backgrounds, genders, locations, age groups, income levels, and the like.

As shown by operation 1110, the apparatus 200 includes means, such as processor 202, memory 204, communications hardware 206, and/or the like, for causing presentation of the advisor response via the advisor GUI. In some embodiments, personalized output generation engine 212 may direct communications hardware 206 to cause transmission of data corresponding to the advisor response to remote device 106A such that remote device 106A may visually display the advisor response via the advisor GUI at entity device 108A via system application 112.

### POU Persona Mapping and Corresponding Actions

In some example embodiments and as discussed below, other approaches relating to the operations outlined and described above in connection with FIG. 3 may be taken by hyper-personalization system 102, which may involve mapping users to predefined personas based on a POU alignment dataset and, based on the determined personas, performing action sets in connection with a hyper-personalized GUI.

In some embodiments, in the context of financial services, each of the example core values discussed above may be mapped with particular financial actions, products, services, and resources. For example, a core value of community may correspond to investing in companies making positive environmental or social change, and example products, services, and resources may include, for example, community investment funds, nonprofit programs, savings accounts, mortgage or home equity loans, and microloans. As another example, a core value of education may correspond to financial planning for future generations to afford education, and example products, services, and resources may include, for example, saving accounts, certificates of deposit (CDs), 529 plans, student loan refinancing, personal loans, and college planning tools. As another example, a core value of family may correspond to an emphasis on multigenerational wealth transfer and supporting extended family needs, and example products, services, and resources may include, for example, credit cards (shared rewards), insurance (e.g., life insurance), trust and estate planning, and retirement accounts and retirement planning. As another example, a core value of security may correspond to prioritizing financial stability, risk mitigation, and protection of assets, and example products, services, and resources may include, for example, Federal Deposit Insurance Corporation (FDIC)-insured checking and/or savings accounts, insurance (to protect assets), retirement accounts and planning, securities-backed lending, risk-appropriate investment portfolios, and life and long-term care insurance. As another example, a core value of value may correspond to seeking cost-effective, transparent financial services and culturally relevant advice, and example products, services, and resources may include, for example, checking accounts with low-fee options, debit and credit rewards cards, investment advisory (e.g., index funds, ETFs), trade platforms, and portfolio management tools.

In some embodiments, in the context of financial services, each of the example aspirations discussed above may be mapped with particular financial actions, products, services, and resources. For example, an aspiration of positive social impact may correspond to investing in companies making positive environmental or social change, and example products, services, and resources may include, for example, socially responsible investing, donor-advised funds (e.g., charitable giving), and venture capital investments. As another example, an aspiration of collaboration may correspond to multigenerational financial planning, and example products, services, and resources may include, for example, financial planning, savings accounts (e.g., joint savings accounts), and global remittance (e.g., supporting family abroad). As another example, an aspiration of legacy protection may correspond to strategies for wealth transfer, estate planning, and preserving for future generations, and example products, services, and resources may include, for example, trust and estate planning, insurance (wealth transfer strategies), charitable remainder trust, and retirement accounts and retirement planning. As another example, an aspiration of peace of mind may correspond to attaining financial stability that reduces anxiety and allows focus on life goals, and example products, services, and resources may include, for example, budgeting and cashflow management, loans for debt consolidation, insurance (e.g., life insurance and asset insurance), credit and lending, zero liability protection for debit cards, and retirement accounts and retirement planning. As another example, an aspiration of authentic living may correspond to aligning financial decisions with core cultural values or personal beliefs, and example products, services, and resources may include, for example, debit and/or credit cards (e.g., travel, causes, etc.), foreign exchange (global connections), and retirement accounts and retirement planning.

In some embodiments, in the context of financial services, each of the example pain points discussed above may be mapped with particular financial actions, products, services, and resources. For example, a pain point of access to capital may correspond to difficulty obtaining financing or investment capital due to systemic bias or lack of networks, and example products, services, and resources may include, for example, small business loans, credit and lending, credit builder account, and retirement accounts and retirement planning. As another example, a pain point of low stock market participation may correspond to limited participation in wealth-building through the stock market due to a lack of education and/or trust, and example products, services, and resources may include, for example, financial institution programs that offer fractional shares or low minimums. As another example, a pain point of increased debt levels may correspond to struggling with high-interest or burdensome debt, and example products, services, and resources may include, for example, debt consolidation, budgeting and cashflow management, and balance transfers. As another example, a pain point of legacy assets may correspond to a lack of or difficulty in managing inherited assets such as properties or businesses, and example products, services, and resources may include, for example, trust and estate planning, credit and lending, and retirement accounts and planning. As another example, a pain point of financial aptitude may correspond to a need for culturally sensitive financial literacy education and guidance, and example products, services, and resources may include, for example, instructional workshops offered by the financial institution, such as financial literacy workshops, and retirement accounts and retirement planning.

In some embodiments, user framework mapping circuitry 213 may determine a score for the user based on information indicated by the POU alignment dataset to map the user to a particular predefined persona. In this regard, in some embodiments, each core value, aspiration, and pain point indicated by the POU alignment dataset may be assigned a value and totaled by adding the values of core values and aspirations and subtracting values of pain points. In some embodiments, if the determined score falls into a score range associated with a particular digital persona, that digital persona may be determined and assigned to the user. For example, a user that selected or otherwise indicated a core value of family (90), an aspiration of positive social impact (87), and a pain point of access to capital (−80) may be assigned a score of 97. This score may then be mapped to a particular digital persona based on the range of values in which the score falls. It is to be appreciated that the numerical values above are for example purposes only, and other numerical values may be assigned to these categories.

Tables A-E below outline several example digital personas, including a “community champion” digital persona, “secure provider” digital persona, “ethical investor” digital persona, “ambitious saver” digital persona, and “legacy builder” digital persona. It is to be appreciated that these example digital personas are for example purposes only, and other digital personas may also be determined other than the digital personas outlined in Tables A-E. As shown in Tables A-E, each digital persona may map to one or more core values, aspirations, pain points, and may further map to aligned goals which may be either highly relevant or moderately relevant.

TABLE A

| Persona | The Community Champion |
|---|---|
| Profile | This individual cares deeply about their |
| | community and wants to make a lasting |
| | impact. They are drawn to financial solutions |
| | that help empower individuals or support |
| | local businesses. They desire financial |
| | education to improve decision-making. |
| Core Values | Community |
| | Education |
| | Family |
| Aspirations | Positive Social Impact |
| | Collaboration |
| | Legacy Protection |
| Pain Points | Increased Debt Levels |
| | Legacy Assets |
| | Financial Aptitude |
| Aligned Goals | Start or Buy a Business |
| (highly relevant) | Support My Family |
| | Engage in Giving and Philanthropy |
| | Align Investing With My Values |
| Aligned Goals | Build and Protect Wealth |
| (moderately relevant) | Manage Spending |
| | Prepare for Emergencies |

TABLE B

| Persona | The Secure Provider |
|---|---|
| Profile | Their primary focus is safeguarding their |
| | family's future. They seek reliable financial |
| | strategies with an emphasis on protection. |
| | Debt management and ensuring a lasting |
| | legacy for loved ones are key concerns. |
| Core Values | Family |
| | Security |
| | Value |
| Aspirations | Peace of Mind |
| | Legacy Protection |
| Pain Points | Increased Debt Levels |
| | Legacy Assets |
| | Financial Aptitude |
| Aligned Goals | Provide for Peace of Mind |
| (highly relevant) | Prepare for Emergencies |
| | Manage Credit and Debt |
| | Prepare for Retirement |
| | Provide for My Family |
| | Make Legacy and Estate Plans |
| Aligned Goals | Build and Protect Wealth |
| (moderately relevant) | Explore Tax Planning Strategies |

TABLE C

| Persona | The Ethical Investor |
|---|---|
| Profile | Driven by social responsibility, this person |
| | wants their investments to align with their |
| | values. They look for ethical companies and |
| | want financial tools that create positive |
| | change while offering a sense of security. |
| Core Values | Community |
| | Security |
| | Value |
| Aspirations | Positive Social Impact |
| | Peace of Mind |
| | Live Authentically |
| Pain Points | Access to Capital |
| | Low Stock Market Participation |
| Aligned Goals | Align Investing with My Values |
| (highly relevant) | Engage in Giving and Philanthropy |
| | Build and Protect Wealth |
| Aligned Goals | Prepare for Retirement |
| (moderately relevant) | Support My Family |

TABLE D

| Persona | The Ambitious Saver |
|---|---|
| Profile | This persona is motivated by long-term goals. |
| | They prioritize learning about financial |
| | strategies for building wealth but may |
| | struggle to find capital for investing or to |
| | manage debt. |
| Core Values | Education |
| | Family |
| | Security |
| Aspirations | Peace of Mind |
| | Legacy Protection |
| | Live Authentically |
| Pain Points | Access to Capital |
| | Increased Debt Levels |
| | Financial Aptitude |
| Aligned Goals | Align Investing With My Values |
| (highly relevant) | Engage in Giving and Philanthropy |
| | Build and Protect Wealth |
| Aligned Goals | Manage Spending |
| (moderately relevant) | Manage Credit and Debt |
| | Prepare for Emergencies |

TABLE E

| Persona | The Legacy Builder |
|---|---|
| Profile | Focuses on establishing a strong financial |
| | foundation for generations to come. They |
| | care about estate planning, wealth transfer, |
| | and might need guidance with complex |
| | legacy-related financial instruments. |
| Core Values | Family |
| | Security |
| Aspirations | Legacy Protection |
| | Peace of Mind |
| Pain Points | Legacy Assets |
| | Financial Aptitude |
| Aligned Goals | Make Legacy and Estate Plans |
| (highly relevant) | Provide for Peace of Mind |
| | Explore Tax Planning Strategies |
| | Manage our Transition out of a Business |
| | Prepare for Retirement |
| Aligned Goals | Build and Protect Wealth |
| (moderately relevant) | Engage in Giving and Philanthropy |

In various embodiments, the apparatus 200 includes means, such as processor 202, memory 204, communications hardware 206, personalized output generation engine 212, and/or the like, for modifying an electronic interface based on the digital persona for the first user. In various embodiments, modifying an electronic interface (e.g., a hyper-personalized GUI) based on the digital persona for the first user may comprise one or more actions performed by the hyper-personalization system 102.

In some embodiments, modifying an electronic interface based on the digital persona for the first user may comprise re-prioritizing advice presented to users (e.g., via the mobile application) and visually presenting the re-prioritized advice. In this regard, the apparatus 200 includes means, such as processor 202, memory 204, communications hardware 206, personalized output generation engine 212, and/or the like, for re-prioritizing an advice list for the first user.

In some embodiments, users for which the system has not received user narrative data for (e.g., due to the user not providing any input to hyper-personalization system 102) may be presented with advice lists in a default or predefined order (e.g., a generic order applicable to all users). However, this default order may be re-prioritized after determining a digital persona for a user based on user narrative data. In various embodiments, advice may only be re-prioritized, and not changed for the user based on their digital persona. As one example, general financial advice may typically suggest investing in personal retirement prior to funding a 529 educational savings account for children; thus, a default advice list may prioritize a retirement account over a 529 account. However, users from certain backgrounds may view their children as a priority over everything else and therefore funding a 529 account may be of higher priority than funding a personal retirement account. In this regard, an advice listing may be re-prioritized to present a 529 account funding as a higher priority than a retirement account funding. In some embodiments, the apparatus 200 includes means, such as processor 202, memory 204, communications hardware 206, personalized output generation engine 212, and/or the like, for causing presentation of the re-prioritized advice list via the electronic interface. In some embodiments, in addition to presenting a re-prioritized advice list, additional interface elements may be presented concerning the re-prioritized advice list. For example, a notification window or similar graphical element may be presented to notify the user of the re-prioritization and how the re-prioritization may impact their financial goals. Continuing with the example above, a user may be notified via a GUI element that prioritizing a 529 account over retirement may delay the user's retirement by a certain number of years. In some embodiments, the example scoring described above may result in one or more advice lists specific to a digital persona determined for the user. In this regard, one or more default advice lists for a user may be re-prioritized based on a determined digital persona.

In some embodiments, an electronic interface based on the digital persona for the first user may comprise determining products and/or service recommendations and visually presenting the product and/or service recommendations via the electronic interface. In this regard, the apparatus 200 includes means, such as processor 202, memory 204, communications hardware 206, personalized output generation engine 212, and/or the like, for determining at least one product or service recommendation for the first user based on the digital persona. The at least one product or service recommendation may be determined based on a mapping of products and services to digital personas. For example, this mapping may be stored in memory (e.g., memory 204) and retrieved to identify which products and/or services align to a given digital persona. Once identified, product and/or service recommendations may be visually presented via one or more electronic interfaces (e.g., within the mobile application). In this regard, the apparatus 200 includes means, such as processor 202, memory 204, communications hardware 206, personalized output generation engine 212, and/or the like, for causing presentation of the at least one product or service recommendation.

FIGS. 3, 5, 7, 8, 9, and 11 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, user narrative data associated with a user;
determining, by a modeling engine, a pillars of understanding (POU) alignment dataset for the user based at least on the user narrative data;
determining, by the modeling engine, an archetype dataset for the user based at least on a portion of the POU alignment dataset;
generating, by a personalized output generation engine, a hyper-personalized graphical user interface (GUI) based on the POU alignment dataset and the archetype dataset;
causing, by the communications hardware, presentation of the hyper-personalized GUI at a user device associated with the user; and
performing, by the personalized output generation engine and based on at least one of the POU alignment dataset and the archetype dataset, an action set in connection with one or more user interactions with the hyper-personalized GUI.

2. The method of claim 1, wherein the archetype dataset is determined from a plurality of archetype datasets, wherein each archetype dataset defines at least (i) a messaging tone, (ii) an engagement frequency, (iii) a sequence of offerings, and (iv) an engagement method.

3. The method of claim 2, wherein determining the archetype dataset comprises:
processing, by archetype determination circuitry, the POU alignment dataset using a trained classifier model, wherein the trained classifier model is trained using at least an archetype taxonomy, and wherein processing the POU alignment dataset using the trained classifier model comprises:
determining, by the archetype determination circuitry and based on the POU alignment dataset, probability scores for each archetype dataset of the plurality of archetype datasets; and
selecting, by the archetype determination circuitry, the archetype dataset based on the probability scores.

4. The method of claim 2, wherein performing the action set comprises:
determining, by the personalized output generation engine, that criteria associated with the engagement frequency of the archetype dataset is satisfied;
generating, by the modeling engine, a first message in accordance with the messaging tone and based on at least one of the POU alignment dataset and the archetype dataset; and
causing, by the communications hardware, presentation of the first message via the hyper-personalized GUI in accordance with the engagement frequency.

5. The method of claim 1, wherein the POU alignment dataset comprises a core values dataset, an aspirations dataset, and a pain points dataset.

6. The method of claim 5, wherein the archetype dataset for the user is determined based on the core values dataset and the aspirations dataset.

7. The method of claim 5, wherein performing the action set comprises:
generating, by the personalized output generation engine, a prioritized solution list based at least on the pain points dataset; and
causing, by the communications hardware, presentation of at least a portion of the prioritized solution list via the hyper-personalized GUI.

8. The method of claim 1, further comprising:
causing, by the communications hardware, presentation of a digital survey at the user device associated with the user,
wherein at least a portion of the user narrative data is received in response to the user responding to the digital survey.

9. The method of claim 1, further comprising:
receiving, by the communications hardware and after presentation of the hyper-personalized GUI at a user device associated with the user, second user narrative data associated with the user; and
generating, by the personalized output generation engine, an updated hyper-personalized GUI based at least on the second user narrative data.

10. The method of claim 1, further comprising:
generating, by the personalized output generation engine, an advisor GUI;
causing, by the communications hardware, presentation of the advisor GUI at an entity device associated with an advisor;
receiving, by the communications hardware and via the advisor GUI, an advisor request comprising user criteria;
generating, by the modeling engine, an advisor response based on the user criteria; and
causing, by the communications hardware, presentation of the advisor response via the advisor GUI.

11. An apparatus comprising:
communications hardware configured to receive user narrative data associated with a user;
a modeling engine configured to:
determine a pillars of understanding (POU) alignment dataset for the user based at least on the user narrative data, and
determine an archetype dataset for the user based at least on a portion of the POU alignment dataset; and
a personalized output generation engine configured to generate a hyper-personalized graphical user interface (GUI) based on the POU alignment dataset and the archetype dataset,
wherein the communications hardware is further configured to cause presentation of the hyper-personalized GUI at a user device associated with the user, and
wherein the personalized output generation engine is further configured to perform, based on at least one of the POU alignment dataset and the archetype dataset, an action set in connection with one or more user interactions with the hyper-personalized GUI.

12. The apparatus of claim 11, wherein the modeling engine determines the archetype dataset from a plurality of archetype datasets, wherein each archetype dataset defines at least (i) a messaging tone, (ii) an engagement frequency, (iii) a sequence of offerings, and (iv) an engagement method.

13. The apparatus of claim 12, wherein the modeling engine comprises archetype determination circuitry, and wherein the archetype determination circuitry determines the archetype dataset by:
processing the POU alignment dataset using a trained classifier model, wherein the trained classifier model is trained using at least an archetype taxonomy, and wherein processing the POU alignment dataset using the trained classifier model comprises:
determining, based on the POU alignment dataset, probability scores for each archetype dataset of the plurality of archetype datasets, and
selecting the archetype dataset based on the probability scores.

14. The apparatus of claim 12, wherein the personalized output generation engine performs the action set by determining that criteria associated with the engagement frequency of the archetype dataset is satisfied,
wherein the modeling engine is further configured to generate a first message in accordance with the messaging tone and based on at least one of the POU alignment dataset and the archetype dataset, and
wherein the communications hardware is further configured to cause presentation of the first message via the hyper-personalized GUI in accordance with the engagement frequency.

15. The apparatus of claim 11, wherein the POU alignment dataset comprises a core values dataset, an aspirations dataset, and a pain points dataset.

16. The apparatus of claim 15, wherein the archetype dataset for the user is determined based on the core values dataset and the aspirations dataset.

17. The apparatus of claim 15, wherein the personalized output generation engine performs the action set by generating a prioritized solution list based at least on the pain points dataset, and
wherein the communications hardware is further configured to cause presentation of at least a portion of the prioritized solution list via the hyper-personalized GUI.

18. The apparatus of claim 11, wherein the communications hardware is further configured to receive, after presentation of the hyper-personalized GUI at a user device associated with the user, second user narrative data associated with the user, and
wherein the personalized output generation engine is further configured to generate an updated hyper-personalized GUI based at least on the second user narrative data.

19. The apparatus of claim 11, wherein the personalized output generation engine is further configured to generate an advisor GUI,
wherein the communications hardware is further configured to:
cause presentation of the advisor GUI at an entity device associated with an advisor, and
receive, via the advisor GUI, an advisor request comprising user criteria;
wherein the modeling engine is further configured to generate an advisor response based on the user criteria, and
wherein the communications hardware is further configured to cause presentation of the advisor response via the advisor GUI.

20. A computer program product comprising at least one non-transitory computer-readable storage medium storing software instructions that, when executed, cause an apparatus to:
receive user narrative data associated with a user;
determine a pillars of understanding (POU) alignment dataset for the user based at least on the user narrative data;
determine an archetype dataset for the user based at least on a portion of the POU alignment dataset;
generate a hyper-personalized graphical user interface (GUI) based on the POU alignment dataset and the archetype dataset;
cause presentation of the hyper-personalized GUI at a user device associated with the user; and
perform, based on at least one of the POU alignment dataset and the archetype dataset, an action set in connection with one or more user interactions with the hyper-personalized GUI.
